(19) United States
(12) Patent Application Publication
(10) Pub. No.: US 2021/0263060 A1
(43) Pub. Date: Aug. 26, 2021

(54) AUTOMATIC ANALYZING APPARATUS

(71) Applicant: Canon Medical Systems Corporation, Otawara-shi (JP)

(72) Inventors: Hirotoshi TAHARA, Nasushiobara (JP); Satoru SUGITA, Nasushiobara (JP)

(73) Assignee: Canon Medical Systems Corporation, Otawara-shi (JP)

(21) Appl. No.: 17/179,611

(22) Filed: Feb. 19, 2021

(30) Foreign Application Priority Data
Feb. 21, 2020 (JP) 2020-028567

(51) Int. Cl. G01N 35/10; G01N 35/02

(52) U.S. Cl. CPC G01N 35/1002; G01N 35/025

(57) ABSTRACT

According to one embodiment, an automatic analyzing apparatus includes a reaction disk, a sample dispensing probe, an extended measurement dispensing probe, a reagent dispensing probe and processing circuitry. The processing circuitry provides the sample into the reaction vessel stopping at a first position on the reaction disk using the sample dispensing probe, provides the first reagent into the reaction vessel stopping at the first position using the extended measurement dispensing probe, moves the reaction vessel stopping at the first position on the reaction disk to a second position by pivoting the reaction disk at a predetermined pivot angle, and provides the second reagent into the reaction vessel stopping at the second position using the reagent dispensing probe.

### CROSS-REFERENCE TO RELATED APPLICATIONS

This application is based upon and claims the benefit of priority from Japanese Patent Applications No. 2020-028567, filed Feb. 21, 2020; and No. 2021-024172, filed Feb. 18, 2021; the entire contents of both of which are incorporated herein by reference.

### FIELD

Embodiments described herein relate generally to an automatic analyzing apparatus.

### BACKGROUND

A conventional automatic analyzing apparatus sometimes performs analysis using two types of reagents. In an inspection process regarding this analysis, it is typical to dispense a specimen sample and a first reagent into a reaction vessel, stir them, dispense a second reagent into the reaction vessel after a predetermined time (for example, 10 min), stir them, and measure the absorbance after the start of analysis. The conventional automatic analyzing apparatus is configured to efficiently perform this inspection process.

In a discrete automatic analyzing apparatus, dispensing positions fora specimen and a reagent are fixed and the rotating operation of the reaction tank is constant in every cycle time in order to perform a series of inspection processes while maintaining the processing speed. It is therefore difficult to execute a different inspection process by the conventional automatic analyzing apparatus. For example, the conventional automatic analyzing apparatus cannot dispense both the first and second reagents into a reaction vessel at arbitrary timings until a reaction disk makes a round while maintaining the processing speed, without affecting the conventional inspection process.

To meet a clinical requirement, the automatic analyzing apparatus needs to perform analysis on many types of inspection items. To perform analysis on many types of inspection items, for example, many types of reagents need to be prepared. To prepare many types of reagents, for example, there is an automatic analyzing apparatus including two reagent storages on the same plane. However, when a reagent storage is further added on the same plane to further add a reagent, the installation area of the automatic analyzing apparatus increases undesirably.

### BRIEF DESCRIPTION OF THE DRAWINGS

FIG. 1 is a block diagram showing the functional arrangement of an automatic analyzing apparatus according to the first embodiment;

FIG. 2 is a schematic view exemplifying the arrangement of an analysis mechanism in FIG. 1;

FIG. 3 is a flowchart showing an example of an analysis operation according to the first embodiment;

FIG. 4 is a plan view showing the analysis mechanism shown in FIG. 2 when viewed from the top;

FIG. 5 is a view showing a section A-A in FIG. 4 viewed from an arrow direction;

FIG. 6 is a view showing another example of the section A-A in FIG. 4 viewed from the arrow direction;

FIG. 7 is a plan view showing another example of FIG. 4;

FIG. 8 is a view showing a section B-B in FIG. 7 viewed from an arrow direction;

FIG. 9 is a schematic view for explaining the arrangement of an extended measurement reagent dispensing unit including an extended measurement dispensing probe in FIG. 5;

FIG. 10 is a graph showing an example of absorbance measurement results in the prior art and the first embodiment;

FIG. 11 is a timing chart showing an example of a conventional inspection process;

FIG. 12 is a timing chart showing an example of an inspection process according to the first embodiment;

FIG. 13 is a schematic view showing the arrangement of the analysis mechanism of an automatic analyzing apparatus according to the second embodiment;

FIG. 14 is a plan view for explaining the arrangement of a linear motion reagent storage in FIG. 13;

FIG. 15 is a plan view showing another example of FIG. 13;

FIG. 16 is a sectional view showing a section C-C including a reagent cartridge incorporating a dispensing function in FIG. 15;

FIG. 17 is a sectional view showing another reagent cartridge in FIG. 16;

FIG. 18 is a flowchart showing an example of an analysis operation according to the second embodiment;

FIG. 19 is a flowchart showing an example of a reagent cartridge replacement operation according to an application example of the second embodiment;

FIG. 20 is a schematic view for explaining the reagent cartridge replacement operation;

FIG. 21 is a schematic view for explaining the reagent cartridge replacement operation;

FIG. 22 is a schematic view for explaining the reagent cartridge replacement operation;

FIG. 23 is a schematic view for explaining the reagent cartridge replacement operation;

FIG. 24 is a schematic view for explaining the reagent cartridge replacement operation; and

FIG. 25 is a schematic view for explaining the reagent cartridge replacement operation.

### DETAILED DESCRIPTION

In general according to one embodiment, an automatic analyzing apparatus includes a reaction disk, a sample dispensing probe, an extended measurement dispensing probe, a reagent dispensing probe and processing circuitry. The reaction disk holds a plurality of reaction vessels. The sample dispensing probe provides a sample. The extended measurement dispensing probe provides a first reagent. The reagent dispensing probe provides a second reagent. The processing circuitry provides the sample into the reaction vessel stopping at a first position on the reaction disk using the sample dispensing probe, provides the first reagent into the reaction vessel stopping at the first position using the extended measurement dispensing probe, moves the reaction vessel stopping at the first position on the reaction disk to a second position by pivoting the reaction disk at a predetermined pivot angle, and provides the second reagent into the reaction vessel stopping at the second position using the reagent dispensing probe.

Embodiments of an automatic analyzing apparatus will now be described in detail with reference to the accompanying drawings.

### First Embodiment

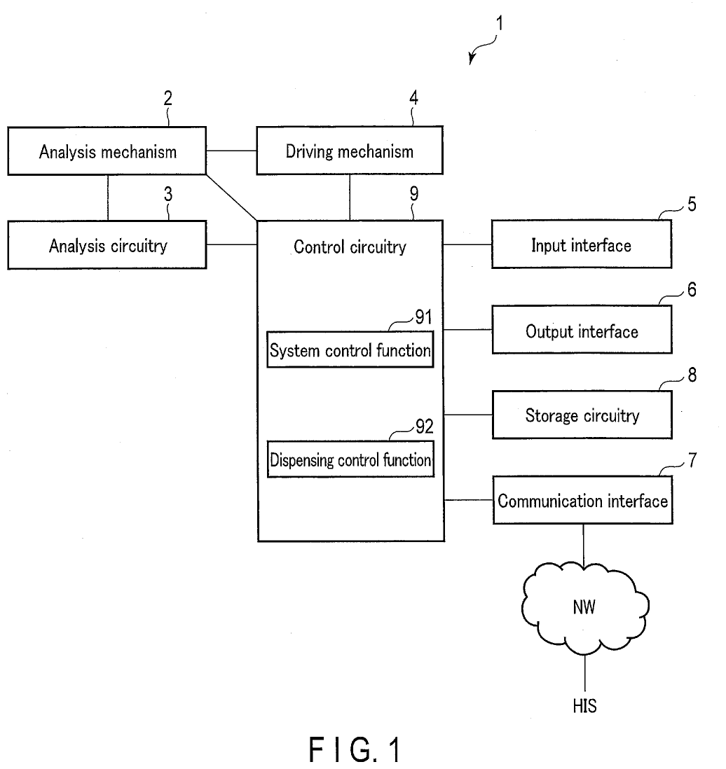

FIG. 1 is a block diagram showing the functional arrangement of an automatic analyzing apparatus according to the first embodiment. An automatic analyzing apparatus 1 shown in FIG. 1 includes an analysis mechanism 2, analysis circuitry 3, a driving mechanism 4, an input interface 5, an output interface 6, a communication interface 7, storage circuitry 8, and control circuitry 9 (control unit).

The analysis mechanism 2 mixes a sample such as a standard sample or an inspection target sample, and a reagent used for each inspection item set for the sample. The analysis mechanism 2 measures a solution mixture of the sample and the reagent, and generates standard data and inspection target data represented by, for example, the absorbance.

The analysis circuitry 3 is a processor configured to generate calibration data, analysis data, and the like by analyzing standard data and inspection target data generated by the analysis mechanism 2. The analysis circuitry 3 reads out an analysis program from the storage circuitry 8, and generates calibration data, analysis data, and the like in accordance with the readout analysis program. For example, based on standard data, the analysis circuitry 3 generates calibration data representing the relationship between the standard data and a standard value set in advance for a standard sample. Based on inspection target data and calibration data of an inspection item corresponding to the inspection target data, the analysis circuitry 3 generates analysis data represented as a concentration value and an enzyme activity value. The analysis circuitry 3 outputs the generated calibration data, analysis data, and the like to the control circuitry 9.

The driving mechanism 4 drives the analysis mechanism 2 under the control of the control circuitry 9. The driving mechanism 4 is implemented by, for example, a gear, a stepping motor, a belt conveyor, and a lead screw.

The input interface 5 accepts, for example, from an operator or via an in-hospital network NW, setting of analysis parameters and the like for each inspection item regarding a measurement-requested sample. The input interface 5 is implemented by, for example, a mouse, a keyboard, and a touch pad configured to input an instruction by touching the operation screen. The input interface 5 is connected to the control circuitry 9, converts an operation instruction (input information) input from the operator into an electrical signal, and outputs the electrical signal to the control circuitry 9.

In this specification, the input interface 5 is not limited to one including physical operation components such as a mouse, keyboard, and touch pad. Another example of the input interface 5 is electrical signal processing circuitry configured to receive an electrical signal corresponding to an operation instruction input from an external input device provided separately from the automatic analyzing apparatus 1, and output the electrical signal to the control circuitry 9.

The output interface 6 is connected to the control circuitry 9 and outputs a signal supplied from the control circuitry 9. The output interface 6 is implemented by, for example, display circuitry, printing circuitry, and an audio device. The display circuitry includes, for example, a CRT display, a liquid crystal display, an organic EL display, an LED display, and a plasma display. The display circuitry may include processing circuitry configured to convert data representing a display target into a video signal and output the video signal to the outside. The printing circuitry includes, for example, a printer. The printing circuitry may include output circuitry configured to output data representing a printing target to the outside. The audio device includes, for example, a loudspeaker. The audio device may include output circuitry configured to output an audio signal to the outside.

The communication interface 7 is connected to, for example, the in-hospital network NW. The communication interface 7 performs data communication with a HIS (Hospital Information System) via the in-hospital network NW. Note that the communication interface 7 may perform data communication with the HIS via a LIS (Laboratory Information System) connected to the in-hospital network NW.

The storage circuitry 8 includes a processor-readable recording medium such as a magnetic recording medium, an optical recording medium, or a semiconductor memory. Note that the storage circuitry 8 need not always be implemented by a single storage device. For example, the storage circuitry 8 may be implemented by a plurality of storage devices.

The storage circuitry 8 stores an analysis program to be executed by the analysis circuitry 3, and a control program for implementing the function of the control circuitry 9. The storage circuitry 8 stores analysis data generated by the analysis circuitry 3 for each inspection item. The storage circuitry 8 stores an inspection order input from the operator, or an inspection order received by the communication interface 7 via the in-hospital network NW.

The control circuitry 9 controls the driving mechanism 4 to drive the analysis mechanism 2. The control circuitry 9 is a processor that functions as the center of the automatic analyzing apparatus 1. The control circuitry 9 executes a control program stored in the storage circuitry 8, implementing a function corresponding to the executed control program. The function of the control circuitry 9 will be described later. Note that the control circuitry 9 may have a storage area for storing at least some of data stored in the storage circuitry 8.

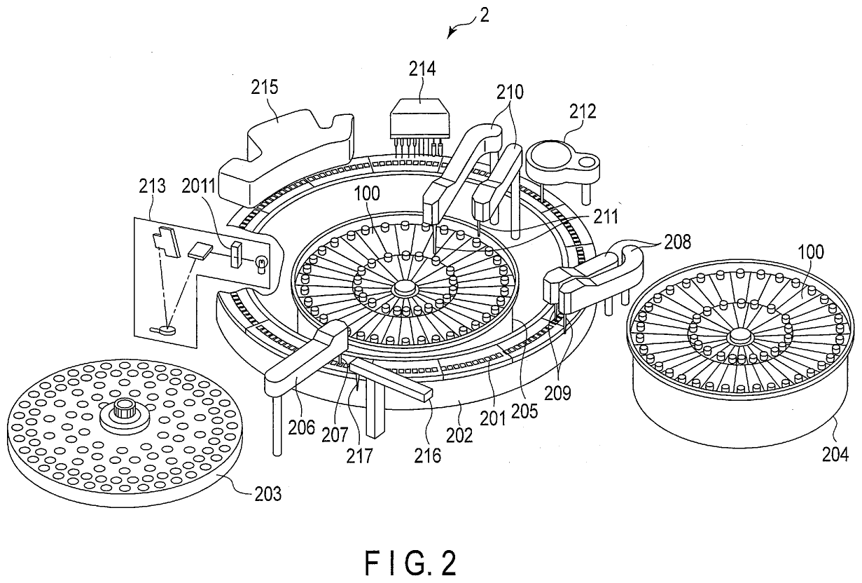

FIG. 2 is a schematic view showing an example of the arrangement of the analysis mechanism 2 shown in FIG. 1. The analysis mechanism 2 shown in FIG. 2 includes a reaction disk 201, a thermostatic portion 202, a sample disk 203, a first reagent storage 204, and a second reagent storage 205. The analysis mechanism 2 also includes a sample dispensing arm 206, a sample dispensing probe 207, first reagent dispensing arms 208, first reagent dispensing probes 209, second reagent dispensing arms 210, second reagent dispensing probes 211, an electrode unit 212, a photometry unit 213, a cleaning unit 214, a stirring unit 215, an extended measurement dispensing arm 216, an extended measurement dispensing probe 217, and a reagent tank (reagent vessel).

The reaction disk 201 annularly arrays and holds a plurality of reaction vessels 2011. The reaction disk 201 conveys the reaction vessels 2011 along a predetermined path. More specifically, the reaction disk 201 alternately repeats pivot and stop by the driving mechanism 4 at a predetermined time interval (to be referred to as one period or one cycle hereinafter), for example, in every 4.5 sec. The reaction vessel 2011 is formed from, for example, glass, PP (PolyPropylene), or acrylic. Note that a sample provide position, a first reagent provide position, a second reagent provide position, a stirring position, and the like are set at a plurality of positions on the reaction disk 201.

The thermostatic portion 202 stores a heating medium set at a predetermined temperature, dips the reaction vessel 2011 into the stored heating medium, and heats up a solution mixture stored in the reaction vessel 2011.

The sample disk 203 annularly arrays and holds a plurality of sample vessels storing a measurement-requested sample. The sample disk 203 conveys the sample vessels along a predetermined path. In the example shown in FIG. 2, the sample disk 203 is arranged next to the reaction disk 201. Note that a sample aspiration position is set at a predetermined position on the sample disk 203. The sample disk 203 may be covered with a detachable cover.

The first reagent storage 204 keeps cold a plurality of reagent vessels storing a first reagent that reacts with a predetermined component of a sample. In the example shown in FIG. 2, the first reagent storage 204 is arranged next to the reaction disk 201. In the first reagent storage 204, a first reagent rack is provided rotatably. The first reagent rack annularly arrays and holds a plurality of reagent vessels. The driving mechanism 4 pivots the first reagent rack. Note that a first reagent aspiration position is set at a predetermined position on the first reagent storage 204. The first reagent storage 204 may store a second reagent. The second reagent is dispensed after the first reagent is dispensed. The reagent vessel may be called a reagent bottle. The first reagent storage 204 may be covered with a detachable reagent cover.

The second reagent storage 205 keeps cold a plurality of reagent vessels storing the second reagent. In the example shown in FIG. 2, the second reagent storage 205 is arranged inside the reaction disk 201. In the second reagent storage 205, a second reagent rack is provided rotatably. The second reagent rack annularly arrays and holds a plurality of reagent vessels. The driving mechanism 4 pivots the second reagent rack. Note that a second reagent aspiration position is set at a predetermined position on the second reagent storage 205. The second reagent storage 205 may be covered with a detachable reagent cover.

The second reagent aspiration position is set at, for example, the position of an intersection point of the pivot track of the second reagent dispensing probe 211 and the movement track of the openings of the reagent vessels annularly arrayed in the second reagent rack.

Next, the sample dispensing arm 206, the sample dispensing probe 207, the first reagent dispensing arms 208, the first reagent dispensing probes 209, the second reagent dispensing arms 210, the second reagent dispensing probes 211, the electrode unit 212, the photometry unit 213, the cleaning unit 214, the stirring unit 215, the extended measurement dispensing arm 216, the extended measurement dispensing probe 217, and the reagent tank will be explained.

The sample dispensing arm 206 is interposed between the reaction disk 201 and the sample disk 203. The sample dispensing arm 206 is provided to be vertically movable and horizontally pivotal by the driving mechanism 4. The sample dispensing arm 206 holds the sample dispensing probe 207 at one end.

The sample dispensing probe 207 pivots along an arcuate pivot track along with the pivot of the sample dispensing arm 206. The sample aspiration position and the sample provide position are set on the pivot track. The sample aspiration position is equivalent to, for example, an intersection point of the pivot track of the sample dispensing probe 207 and the movement track of the sample vessels annularly arrayed on the sample disk 203. The sample provide position is equivalent to, for example, an intersection point of the pivot track of the sample dispensing probe 207 and the movement track of the reaction vessels 2011 annularly arrayed on the reaction disk 201.

The sample dispensing probe 207 is driven by the driving mechanism 4 to vertically move immediately above (sample aspiration position) the opening of the sample vessel held by the sample disk 203 or immediately above (sample provide position) the opening of the reaction vessel 2011 held by the reaction disk 201.

The sample dispensing probe 207 aspirates a sample from a sample vessel positioned immediately below the sample aspiration position under the control of the control circuitry 9. The sample dispensing probe 207 provides the aspirated sample to the reaction vessel 2011 positioned immediately below the sample provide position under the control of the control circuitry 9. The sample dispensing probe 207 executes a series of dispensing operations of aspiration and provide, for example, once in a cycle.

Each first reagent dispensing arm 208 is interposed between, for example, the reaction disk 201 and the first reagent storage 204. The first reagent dispensing arm 208 is provided to be vertically movable and horizontally pivotal by the driving mechanism 4. The first reagent dispensing arm 208 holds the first reagent dispensing probe 209 at one end.

The first reagent dispensing probe 209 pivots along an arcuate pivot track along with the pivot of the first reagent dispensing arm 208. The first reagent aspiration position and the first reagent provide position are set on the pivot track. The first reagent aspiration position is equivalent to, for example, an intersection point of the pivot track of the first reagent dispensing probe 209 and the movement track of the openings of the reagent vessels annularly arrayed on the first reagent rack. The first reagent provide position is equivalent to, for example, an intersection point of the pivot track of the first reagent dispensing probe 209 and the movement track of the reaction vessels 2011 annularly arrayed on the reaction disk 201.

The first reagent dispensing probe 209 is driven by the driving mechanism 4 to vertically move immediately above (first reagent aspiration position) the opening of the reagent vessel held by the first reagent rack or immediately above (first reagent provide position) the opening of the reaction vessel 2011 held by the reaction disk 201.

The first reagent dispensing probe 209 aspirates the first reagent from a reagent vessel positioned immediately below the first reagent aspiration position under the control of the control circuitry 9. The first reagent dispensing probe 209 provides the aspirated first reagent to the reaction vessel 2011 positioned immediately below the first reagent provide position under the control of the control circuitry 9. The first reagent dispensing probe 209 executes a series of dispensing operations of aspiration and provide, for example, once in a cycle. Note that the series of dispensing operations are similar to those executed when the first reagent dispensing probe 209 dispenses the second reagent.

Each second reagent dispensing arm 210 is interposed between, for example, the reaction disk 201 and the second reagent storage 205. The second reagent dispensing arm 210 is provided to be vertically movable and horizontally pivotal by the driving mechanism 4. The second reagent dispensing arm 210 holds the second reagent dispensing probe 211 at one end.

The second reagent dispensing probe 211 pivots along an arcuate pivot track along with the pivot of the second reagent dispensing arm 210. The second reagent aspiration position and the second reagent provide position are set on the pivot track. The second reagent aspiration position is equivalent to, for example, an intersection point of the pivot track of the second reagent dispensing probe 211 and the movement track of the openings of the reagent vessels annularly arrayed on the second reagent rack. The second reagent provide position is equivalent to, for example, an intersection point of the pivot track of the second reagent dispensing probe 211 and the movement track of the reaction vessels 2011 annularly arrayed on the reaction disk 201.

The second reagent dispensing probe 211 is driven by the driving mechanism 4 to vertically move immediately above (second reagent aspiration position) the opening of the reagent vessel held by the second reagent rack or immediately above (second reagent provide position) the opening of the reaction vessel 2011 held by the reaction disk 201.

The second reagent dispensing probe 211 aspirates the second reagent from a reagent vessel positioned immediately below the second reagent aspiration position under the control of the control circuitry 9. The second reagent dispensing probe 211 provides the aspirated second reagent to the reaction vessel 2011 positioned immediately below the second reagent provide position under the control of the control circuitry 9. The second reagent dispensing probe 211 executes a series of dispensing operations of aspiration and provide, for example, once in a cycle.

The extended measurement dispensing arm 216 is provided near, for example, the sample provide position on the reaction disk 201. The extended measurement dispensing arm 216 is provided to be linearly movable in, for example, a specific direction on the horizontal plane by the driving mechanism 4. The extended measurement dispensing arm 216 holds the extended measurement dispensing probe 217 at one end.

The extended measurement dispensing probe 217 moves in a specific direction along with the linear motion of the extended measurement dispensing arm 216. The movement destination is the sample provide position.

The extended measurement dispensing probe 217 is driven by the driving mechanism 4 to reciprocate between a retraction position and the sample provide position. The retraction position is, for example, a position where the extended measurement dispensing probe 217 does not interfere with the pivot of the sample dispensing arm. 206 and sample dispensing probe 207.

The extended measurement dispensing probe 217 provides the first reagent aspirated from the reagent tank (not shown) to the reaction vessel 2011 positioned immediately below the sample provide position under the control of the control circuitry 9. The extended measurement dispensing probe 217 executes this provide operation, for example, once in a cycle.

Note that the extended measurement dispensing arm 216 and the extended measurement dispensing probe 217 may be pivotally provided as long as they do not interfere with the operation of the sample dispensing arm 206 and sample dispensing probe 207.

The reagent tank is provided in, for example, the housing of the automatic analyzing apparatus 1. The reagent tank stores a buffer solution used for the sample. The buffer solution is used to dilute the sample. Note that the buffer solution is called the first reagent.

The electrode unit 212 is provided near the outer surface of the reaction disk 201. The electrode unit 212 measures the electrolytic concentration of a solution mixture of the sample and reagent provided into the reaction vessel 2011. The electrode unit 212 includes an ISE (Ion Selective Electrode) and a reference electrode. The electrode unit 212 measures a potential between the ISE and the reference electrode for a solution mixture containing a measurement target ion under the control of the control circuitry 9. The electrode unit 212 outputs data of the measured potential as standard data or inspection target data to the analysis circuitry 3.

The photometry unit 213 is provided near the outer surface of the reaction disk 201. The photometry unit 213 optically measures a predetermined component of the solution mixture of the sample and reagent provided into the reaction vessel 2011. The photometry unit 213 includes a light source and a photodetector. The photometry unit 213 emits light from the light source under the control of the control circuitry 9. The emitted light enters the reaction vessel 2011 from its first side wall and exits from the second side wall opposing the first side wall. The photometry unit 213 detects the light emerging from the reaction vessel 2011 by the photodetector.

More specifically, the photodetector detects light having passed through a solution mixture of a standard sample and reagent in the reaction vessel 2011, and generates standard data represented by the absorbance or the like based on the intensity of the detected light. The photodetector detects light having passed through a solution mixture of an inspection target sample and reagent in the reaction vessel 2011, and generates inspection target data represented by the absorbance or the like based on the intensity of the detected light. The photometry unit 213 outputs the generated standard data and inspection target data to the analysis circuitry 3.

The cleaning unit 214 is provided near the outer surface of the reaction disk 201. The cleaning unit 214 cleans the inside of the reaction vessel 2011 for which the electrode unit 212 or the photometry unit 213 has ended the measurement of the solution mixture. The cleaning unit 214 includes a cleaning fluid supply pump (not shown) configured to supply a cleaning fluid for cleaning the reaction vessel 2011. The cleaning unit 214 includes a cleaning nozzle configured to provide into the reaction vessel 2011 the cleaning fluid supplied from the cleaning fluid supply pump, and aspirate each of the solution mixture and cleaning fluid in the reaction vessel 2011.

The stirring unit 215 is provided near the outer surface of the reaction disk 201. The stirring unit 215 includes a stirring bar, and stirs with the stirring bar a solution mixture of the sample and first reagent stored in the reaction vessel 2011 positioned at the stirring position on the reaction disk 201. The stirring unit 215 stirs a solution mixture of the sample, first reagent, and second reagent stored in the reaction vessel 2011.

Next, the function of the control circuitry 9 according to the first embodiment will be described. For example, the control circuitry 9 implements a system control function 91 and a dispensing control function 92 by executing a control program. Although a case in which the system control function 91 and the dispensing control function 92 are implemented by a single processor will be described in the first embodiment, the present invention is not limited to this. For example, the control circuitry may be constituted by combining a plurality of independent processors, and the system control function 91 and the dispensing control function 92 may be implemented by executing a control program by each processor.

With the system control function 91, the control circuitry 9 supervises and controls the respective units in the automatic analyzing apparatus 1 based on, for example, information input from the input interface 5. More specifically, the control circuitry 9 controls the pivot operation of the reaction disk 201, the pivot and dispensing operations of the sample dispensing probe 207, the pivot and dispensing operations of the first reagent dispensing probe 209, the pivot and dispensing operations of the second reagent dispensing probe 211, and the like.

The control circuitry 9 executes a function regarding dispensing control processing in accordance with a readout control program. This function is, for example, the dispensing control function 92. Note that the dispensing control function 92 may include part of the system control function 91.

The dispensing control function 92 is a function of controlling the respective units in order to execute, for example, an inspection process according to the first embodiment different from a conventional inspection process. In the conventional inspection process, a sample and a first reagent are dispensed and stirred in a reaction vessel, a second reagent is dispensed and stirred several ten cycles after the reaction between the sample and the first reagent progresses, and the absorbance from the start of analysis is measured. To the contrary, in the inspection process according to the first embodiment, a sample, a first reagent, and a second reagent are dispensed and stirred in a reaction vessel, and the absorbance from the start of analysis is measured in a period until the reaction disk makes a round. One round is about 360°-pivot of the reaction disk.

The automatic analyzing apparatus 1 according to the first embodiment can perform measurement in the conventional inspection process and measurement in an inspection process in which the reaction time is extended. In the inspection process (conventional inspection process) of a normal reaction time, the second reagent is dispensed about 5 min after the sample and the first reagent are dispensed, and photometry data is collected for about 10 min after the sample and the first reagent are dispensed. In the reaction time-extended inspection process, the second reagent is dispensed within about 1 min after the sample and the first reagent are dispensed, and photometry data is collected for about 10 min after the sample and the first reagent are dispensed. The reaction time-extended inspection process can perform highly sensitive measurement because it can ensure a longer collection time of photometry data after the second reagent is dispensed, compared to the normal inspection process. Since the time until the second reagent is dispensed after the sample and the first reagent are dispensed is shortened in the reaction time-extended inspection process, inspection can be performed at a processing speed (processing time) at which the time of the inspection process is equal to that of the inspection process of the normal reaction time.

Note that the inspection process (normal measurement) of the normal reaction time and the reaction time-extended inspection process (highly sensitive measurement) may be switched in accordance with, for example, the type of reagent. For example, an instruction for normal measurement or highly sensitive measurement is associated with an inspection item, and the control circuitry 9 switches the inspection process depending on the inspection item. More specifically, a flag for executing highly sensitive measurement is added to an inspection item, and the control circuitry 9 executes switching from normal measurement to highly sensitive measurement in response to this flag.

The inspection process may be switched in accordance with an instruction from the operator. For example, normal measurement or highly sensitive measurement is designated in an inspection order, and the control circuitry 9 switches the inspection process in accordance with the inspection order. Even for the same inspection item, the control circuitry 9 can switch the inspection process between normal measurement and highly sensitive measurement and execute it. For example, when performing reinspection for an inspection item for which normal measurement has been performed, the operator can designate highly sensitive measurement in an inspection order to switch the inspection process of the inspection item subjected to reinspection from normal measurement to highly sensitive measurement.

Next, the operation of the automatic analyzing apparatus 1 having the above arrangement according to the first embodiment will be described in accordance with the processing sequence of the control circuitry 9.

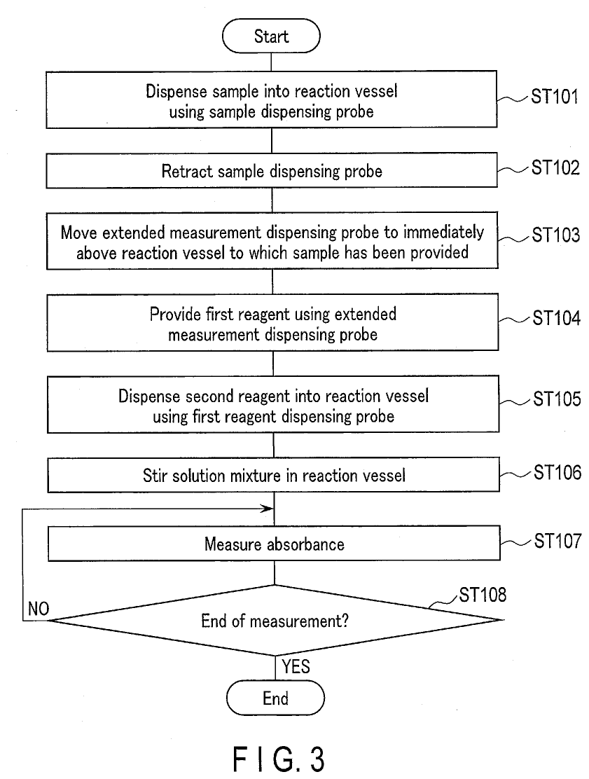

FIG. 3 is a flowchart showing an example of an analysis operation according to the first embodiment. The flowchart in FIG. 3 starts when, for example, the operator executes a dispensing control processing program.

In the first embodiment, when executing the dispensing control processing program, the reagent tank (not shown) stores a buffer solution (first reagent) and the first reagent storage 204 keeps cold a plurality of reagent vessels storing the second reagent. For example, for dispensing control regarding measurement of the normal reaction time, the first reagent in the first reagent storage 204 and the second reagent in the second reagent storage 205 are used. For dispensing control regarding reaction time-extended measurement, the first reagent in the reagent tank and the second reagent in the first reagent storage 204 are used. That is, the extended measurement dispensing probe 217 provides the first reagent into a reaction vessel, and the first reagent dispensing probe 209 of the first reagent dispensing arm 208 provides the second reagent into the reaction vessel.

A description “under the control of the control circuitry 9” when the control circuitry 9 controls each unit, and a description “driven by the driving mechanism 4” when the driving mechanism 4 drives each unit will be omitted.

(Step ST101)

When dispensing control processing starts, the control circuitry 9 executes the dispensing control function 92. After executing the dispensing control function 92, the control circuitry 9 dispenses the sample into the reaction vessel using the sample dispensing probe 207.

More specifically, at the sample aspiration position, the sample dispensing probe 207 moves down to a position where it can aspirate the sample. After moving down, the sample dispensing probe 207 aspirates the sample from the sample vessel. After aspirating the sample, the sample dispensing probe 207 moves up to a position where it can pivot. After moving up, the sample dispensing probe 207 pivots to the sample provide position (first position) along the pivot track. After pivoting, the sample dispensing probe 207 moves down to a position where it can provide the sample. After moving down, the sample dispensing probe 207 provides the aspirated sample into the reaction vessel 2011.

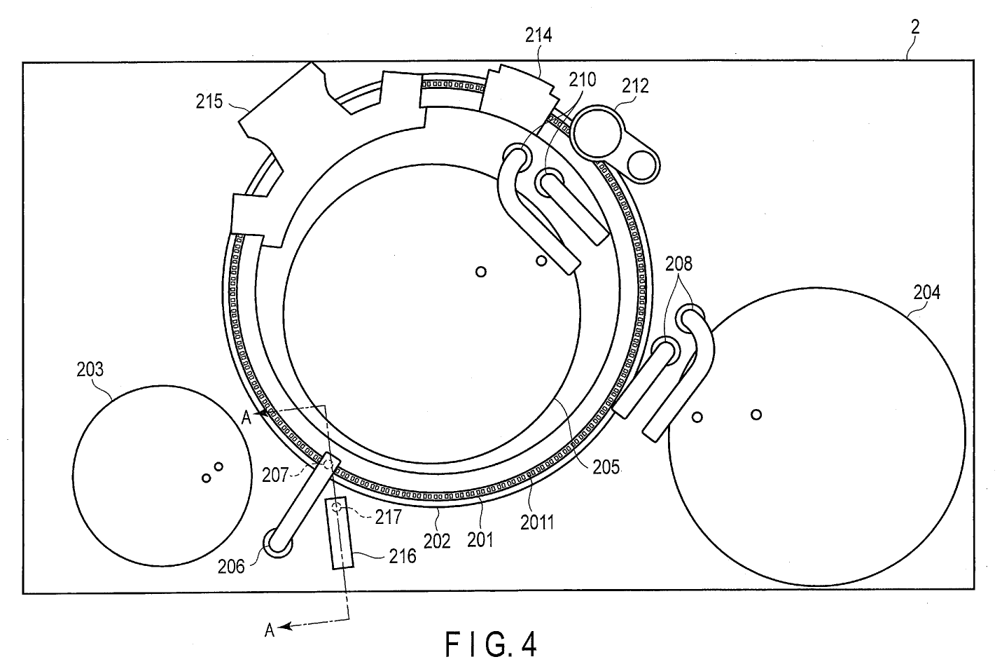

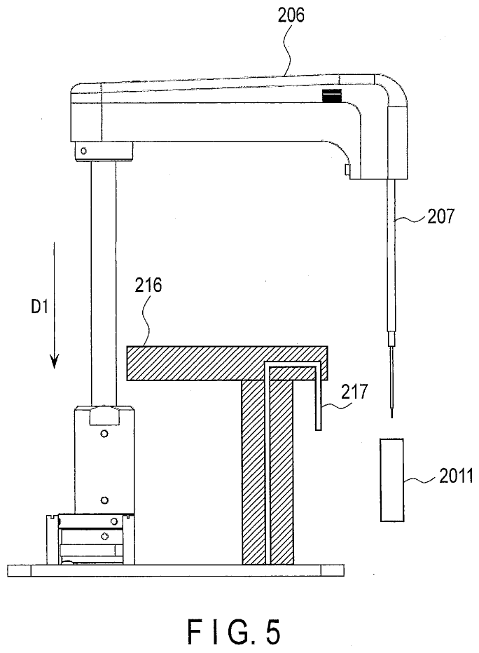

FIG. 4 is a plan view showing the analysis mechanism shown in FIG. 2 when viewed from the top. FIG. 5 is a view showing a section A-A in FIG. 4 viewed from an arrow direction. FIG. 5 shows a state in which the sample dispensing arm 206 moves to above the reaction disk 201.

More specifically, FIG. 5 shows a section (section A-A) of the extended measurement dispensing arm 216 and extended measurement dispensing probe 217 in the linear motion direction, a section of the reaction vessel 2011, the sample dispensing arm 206, and the sample dispensing probe 207.

The sample dispensing probe 207 moves in a down direction D1 immediately above the reaction vessel 2011 for which the first position is set. At this time, the extended measurement dispensing arm 216 and the extended measurement dispensing probe 217 retract to a position where they do not interfere with the operation of the sample dispensing probe 207.

(Step ST102)

After dispensing the sample into the reaction vessel, the control circuitry 9 retracts the sample dispensing probe 207 by the dispensing control function 92. More specifically, after providing the sample, the sample dispensing probe 207 moves up to the position where it can pivot. After moving up, the sample dispensing probe 207 pivots to the sample aspiration position along the pivot track. Note that the position to which the sample dispensing probe 207 retracts may be the sample aspiration position or a position where it does not contact the extended measurement dispensing arm 216 and the extended measurement dispensing probe 217 within a pivot range from the sample provide position (first position) to the sample aspiration position.

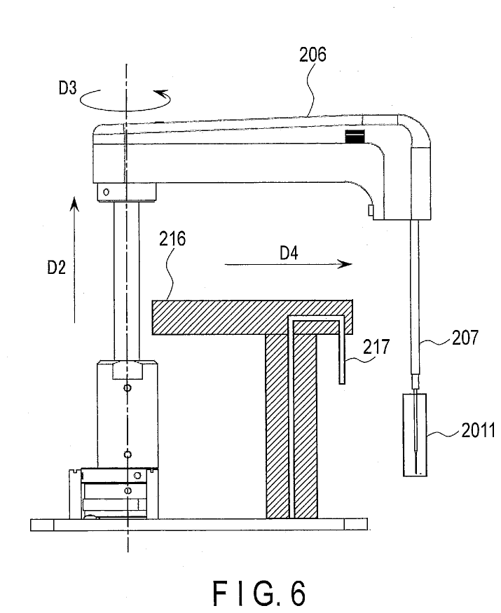

FIG. 6 is a view showing another example of the section A-A in FIG. 4 viewed from the arrow direction. FIG. 6 shows a state in which the sample dispensing probe 207 in FIG. 5 moves down.

The sample dispensing probe 207 inserts one end into almost the bottom of the reaction vessel 2011, and then provides the aspirated/held sample. After providing the sample, the sample dispensing probe 207 moves in an up direction D2 and extracts the end from the reaction vessel 2011. The sample dispensing probe 207 pivots, for example, in a counterclockwise direction D3 about the other end of the sample dispensing arm 206. After pivoting, the extended measurement dispensing probe 217 moves in a linear motion direction D4 toward the reaction vessel 2011 to which the sample has been provided.

(Step ST103)

After the sample dispensing probe 207 retracts, the control circuitry 9 moves the extended measurement dispensing probe 217 by the dispensing control function 92 to immediately above the reaction vessel to which the sample has been provided. More specifically, after the sample dispensing probe 207 retracts, the extended measurement dispensing probe 217 linearly moves to the first position.

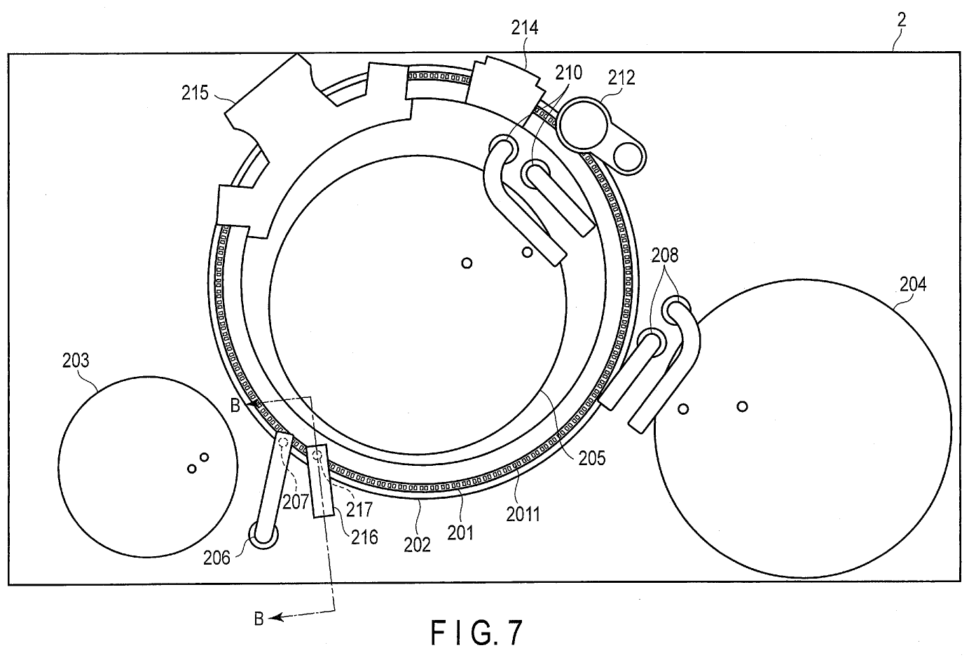

FIG. 7 is a plan view showing another example of FIG. 4 FIG. 7 shows a state in which the sample dispensing arm 206 pivots to retract the extended measurement dispensing arm 216, and the extended measurement dispensing arm 216 linearly moves to immediately above the reaction vessel 2011 of the reaction disk 201.

(Step ST104)

After the extended measurement dispensing probe 217 linearly moves, the control circuitry 9 provides the first reagent by the dispensing control function 92 using the extended measurement dispensing probe 217. More specifically, the extended measurement dispensing probe 217 provides the first reagent into the reaction vessel 2011.

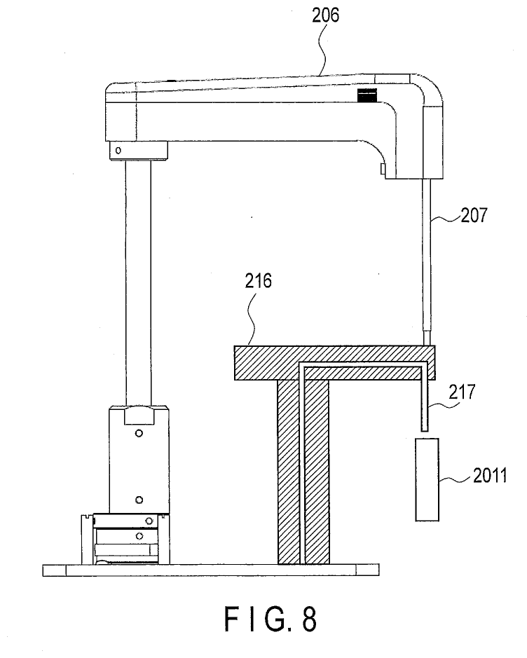

FIG. 8 is a view showing a section B-B in FIG. 7 viewed from an arrow direction. FIG. 8 shows a state in which the sample dispensing arm 206 retracts from above the reaction disk 201 and the extended measurement dispensing arm 216 moves to above the reaction vessel 2011.

More specifically, FIG. 8 shows a section (section B-B) of the extended measurement dispensing arm 216 and extended measurement dispensing probe 217 in the linear motion direction, a section of the reaction vessel 2011, the sample dispensing arm 206, and the sample dispensing probe 207.

After linearly moving to the first position, the extended measurement dispensing probe 217 provides the first reagent into the reaction vessel 2011 to which the sample has just been provided. That is, the first reagent is provided into the reaction vessel 2011 at the first position serving as a position where the sample has been provided.

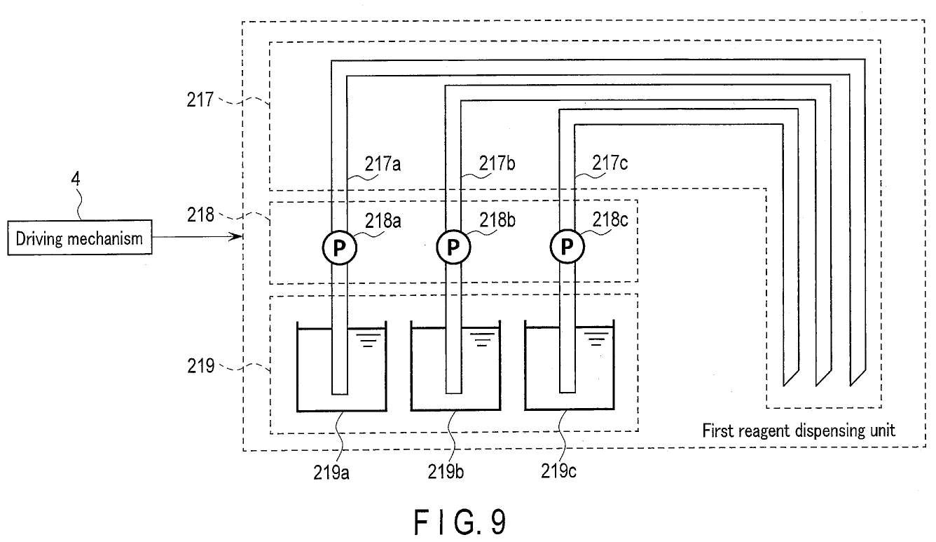

FIG. 9 is a schematic view for explaining the arrangement of an extended measurement reagent dispensing unit including the extended measurement dispensing probe 217 in FIG. 5. The extended measurement reagent dispensing unit shown in FIG. 9 includes the extended measurement dispensing probe 217, a pump 218, and a reagent tank 219. The pump 218 is, for example, a bulbless metering pump. An extended measurement reagent dispensing unit capable of dispensing three types of reagents will be exemplified. The three types of reagents include, for example, a diluent and a buffer solution.

The extended measurement dispensing probe 217 includes a first probe 217a, a second probe 217b, and a third probe 217c respectively for the three types of reagents. Similarly, the pump 218 includes a first pump 218a, a second pump 218b, and a third pump 218c. The reagent tank 219 includes a first tank 219a, a second tank 219b, and a third tank 219c.

The first probe 217a aspirates a reagent stored in the first tank 219a using the first pump 218a. The second probe 217b aspirates a reagent stored in the second tank 219b using the second pump 218b. The third probe 217c aspirates a reagent stored in the third tank 219c using the third pump 218c.

One end of the first probe 217a, one end of the second probe 217b, and one end of the third probe 217c provide the aspirated reagents, respectively. These ends are arranged in the linear motion direction of the extended measurement dispensing arm 216.

As described above, when a plurality of (for example, three) reagents are used as the first reagent, the control circuitry 9 linearly moves the extended measurement dispensing arm 216 to move one end of the first probe 217a, one end of the second probe 217b, or one end of the third probe 217c to immediately above the reaction vessel 2011.

After step ST104, the control circuitry 9 pivots the reaction disk 201 by, for example, one cycle. By this pivoting, the reaction vessel 2011 at the sample provide position (first position) moves to the first reagent provide position (second position).

(Step ST105)

After pivoting the reaction vessel to which the sample and the first reagent have been provided, the control circuitry 9 dispenses the second reagent into the reaction vessel by the dispensing control function 92 using the first reagent dispensing probe 209. More specifically, the first reagent dispensing probe 209 aspirates the second reagent stored in the first reagent storage 204 and provides it into the reaction vessel 2011 to which the sample and the first reagent have been provided. That is, the second reagent is provided into the reaction vessel 2011 at the second position. The operation of the first reagent dispensing probe 209 is almost similar to that of the sample dispensing probe 207, and a description thereof will be omitted.

After step ST105, the control circuitry 9 pivots the reaction disk 201 by, for example, two cycles. By this pivoting, the reaction vessel 2011 at the second position moves to the stirring position.

(Step ST106)

After pivoting the reaction vessel to which the second reagent has been provided, the control circuitry 9 stirs the solution mixture in the reaction vessel 2011.

After step ST106, the control circuitry 9 pivots the reaction disk 201.

(Step ST107)

The reaction vessel 2011 passes through the photometry unit 213 until the reaction disk 201 is rotated, the sample is dispensed into the reaction vessel, and the reaction disk 201 makes a round. When the reaction vessel 2011 passes through the photometry unit 213, the control circuitry 9 measures the absorbance of the solution mixture held in the reaction vessel 2011.

(Step ST108)

The control circuitry 9 determines, for example, whether the absorbance measurement count has reached a predetermined value. If the absorbance measurement count has reached the predetermined value, the process ends. If the absorbance measurement count has not reached the predetermined value, the process returns to step ST107. After step ST108, the processing in the flowchart of FIG. 3 ends.

Note that a series of processes from step ST101 to step ST104 is performed during one cycle. For example, the sample is provided into the reaction vessel in the first half of one cycle, and the first reagent is provided in the second half of one cycle. That is, the sample and the first reagent are provided into the reaction vessel in the same cycle. A series of processes from step ST101 to step ST105 is performed while the reaction disk makes a round. That is, the sample, the first reagent, and the second reagent are provided into the reaction vessel in a period in which the reaction disk makes a round.

The above operation will be summarized. The automatic analyzing apparatus 1 includes the reaction disk 201 configured to hold a plurality of reaction vessels including the reaction vessels 2011, the sample dispensing probe 207 configured to provide a sample into the reaction vessel 2011 stopping at the sample provide position (first position) on the reaction disk 201, the extended measurement dispensing probe 217 configured to dispense the first reagent into the reaction vessel 2011 stopping at the first position, the control circuitry 9 configured to move the reaction vessel 2011 stopping at the first position on the reaction disk 201 to the first reagent provide position (second position) by pivoting the reaction disk 201 by one cycle, and the first reagent dispensing probe 209 of the first reagent dispensing arm 208 configured to provide the second reagent into the reaction vessel 2011 stopping at the second position.

As described above, the automatic analyzing apparatus according to the first embodiment includes the reaction disk configured to hold a plurality of reaction vessels, the sample dispensing probe configured to provide a sample into the reaction vessel stopping at the first position on the reaction disk, the extended measurement dispensing probe configured to provide the first reagent into the reaction vessel stopping at the first position, the control unit configured to move the reaction vessel stopping at the first position on the reaction disk to the second position by pivoting the reaction disk at a predetermined pivot angle, and the reagent dispensing probe configured to provide the second reagent into the reaction vessel stopping at the second position.

In the automatic analyzing apparatus, the sample dispensing probe may provide the sample into the reaction vessel stopping at the first position, and the extended measurement dispensing probe may provide the first reagent into the reaction vessel stopping at the first position within one round in a period in which the reaction disk is pivoted at a predetermined pivot angle. In the automatic analyzing apparatus, the control unit may move the reaction vessel stopping at the first position to the second position while the reaction disk makes a round.

The reaction disk of the automatic analyzing apparatus performs rotation and stop in every cycle, and the sample dispensing probe and the extended measurement dispensing probe may dispense the sample and the first reagent during the stop period in one cycle.

The automatic analyzing apparatus according to the first embodiment can provide the sample and the first reagent into the reaction vessel in the same cycle, and can perform analysis in a process different from the inspection process of the normal reaction time. The automatic analyzing apparatus can ensure a reaction time longer than a conventional reaction time as for the reaction time after dispensing the second reagent because the automatic analyzing apparatus can provide the sample, the first reagent, and the second reagent into the reaction vessel until the reaction disk makes a round.

Hence, the automatic analyzing apparatus according to the first embodiment can perform analysis in a different inspection process while maintaining the processing speed.

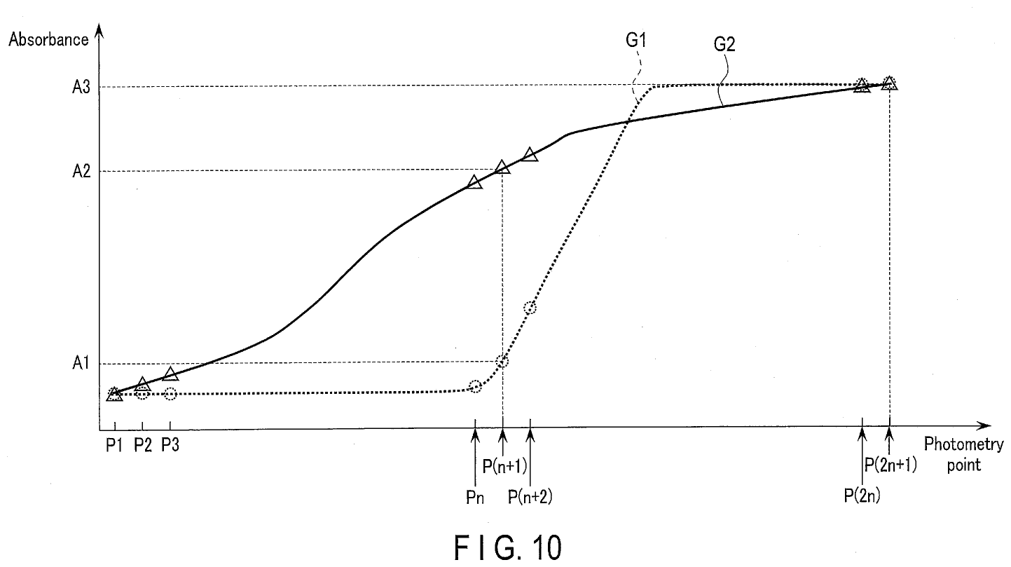

FIG. 10 is a graph showing an example of absorbance measurement results in the prior art and the first embodiment. A graph G1 in FIG. 10 represents a measurement result by the conventional inspection process, and a graph G2 represents a measurement result by the inspection process according to the first embodiment. In both the graphs G1 and G2, the abscissa represents the photometry point and the ordinate represents the absorbance. The photometry point is a count at which the photometry unit 213 measures the absorbance at a predetermined position while the reaction disk makes a round. For example, a photometry point P1 is equivalent to detection in the first round (first time), and a photometry point P2 is equivalent to detection in the second round (second time). The absorbance is calculated based on light detected at the photometry point.

In FIG. 10, measurement is performed (2n+1) times from the photometry point P1 to a photometry point P (2n+1). For example, for n=16, measurement is performed 33 times in total. A photometry point. P (n+1) is the first photometry point after the second reagent is dispensed in the conventional inspection process, and is equivalent to almost half the total reaction time.

The graphs G1 and G2 in FIG. 10 represent absorbances A1 and A2 at the photometry point P (n+1), respectively. The value of the absorbance A2 is larger than that of the absorbance A1. Although the absorbance converges to an absorbance A3 at the photometry point P(2n+1) at the end of inspection on the two graphs, the absorbance changes steeply from the photometry point P(n+1) on the graph G1 and gradually from the start of inspection toward the end of inspection on the graph G2.

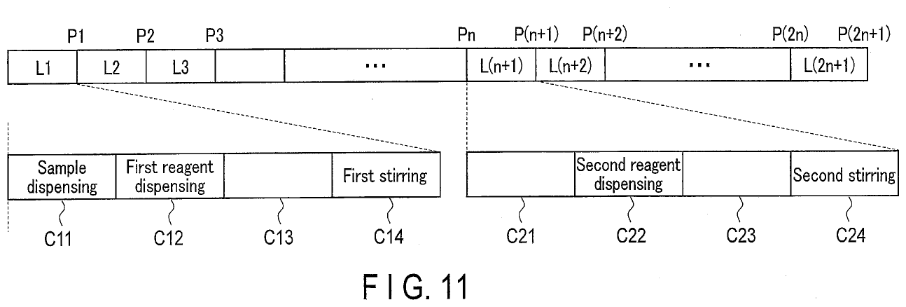

FIG. 11 is a timing chart showing an example of the conventional inspection process. FIG. 11 exemplifies the conventional inspection process from the first round L1 to the (2n+1)th round L(2n+1) representing rotation counts of the reaction disk. In FIG. 11, for example, the reaction disk makes a round by operations of four cycles. Also, for example, photometry is performed at a timing when the reaction vessel passes through the photometry unit immediately before the reaction disk has made a round.

In FIG. 11, operations from a cycle C11 to a cycle C14 are performed in the first round L1. For example, sample dispensing is performed in the cycle C11, first reagent dispensing is performed in the cycle C12, and first stirring is performed in the cycle C14. In the second round L2 and subsequent circuits, the time until the second reagent is dispensed is allocated to the reaction time of the sample and first reagent. In the (n+1)th round L(n+1), operations from a cycle C21 to a cycle C24 are performed. Second reagent dispensing is performed in the cycle C22, and second stirring is performed in the cycle C24. No operation other than the pivot of the reaction disk is performed in the cycles C13, C21, and C23, but the operation is not limited to this. For example, the operations in one round of the reaction disk are not limited to those in the cycles of FIG. 11, and it is also possible to perform first stirring in the cycle C13 and only pivot the reaction disk in the cycle C14.

In the conventional inspection process of the normal reaction time, the automatic analyzing apparatus needs to stand by for almost half the total time until the second reagent is dispensed after the first reagent is dispensed, as shown in FIG. 11. During the standby time, the absorbance may not change even slightly. For example, on the graph G1 of FIG. 10, the absorbance does not change even slightly from the photometry point P1 to the photometry point Pn immediately before the second reagent is dispensed.

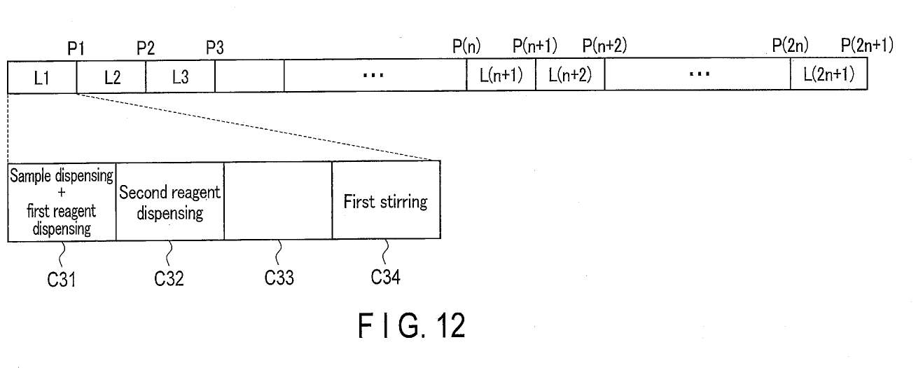

FIG. 12 is a timing chart showing an example of the inspection process according to the first embodiment. In FIG. 12, the reaction disk makes a round by operations of four cycles. For example, photometry is performed at a timing when the reaction vessel passes through the photometry unit immediately before the reaction disk has made a round.

In FIG. 12, operations from a cycle C31 to a cycle C34 are performed in the first round L1. Both sample dispensing and first reagent dispensing are performed in the cycle C31, second reagent dispensing is performed in the cycle C32, and first stirring is performed in the cycle C34.

In the inspection process according to the first embodiment, both the first and second reagents are dispensed in the first round L1, as shown in FIG. 12, so the time until the second reagent is dispensed after the first reagent is dispensed becomes much shorter than that in the conventional inspection process. For example, the reaction time after the second reagent is dispensed can be set to be almost double the reaction time in the conventional inspection process. Since the reaction time after the second reagent is dispensed can be set long, a reaction in which the absorbance changes gradually from the start of inspection toward the end of inspection can be executed. For example, the extension of the reaction can be determined at the early stage after the start of inspection.

### Second Embodiment

In the first embodiment, the second reagent that is dispensed into a reaction vessel is stored in the first reagent storage. In the second embodiment, the second reagent is stored in a linear motion reagent storage.

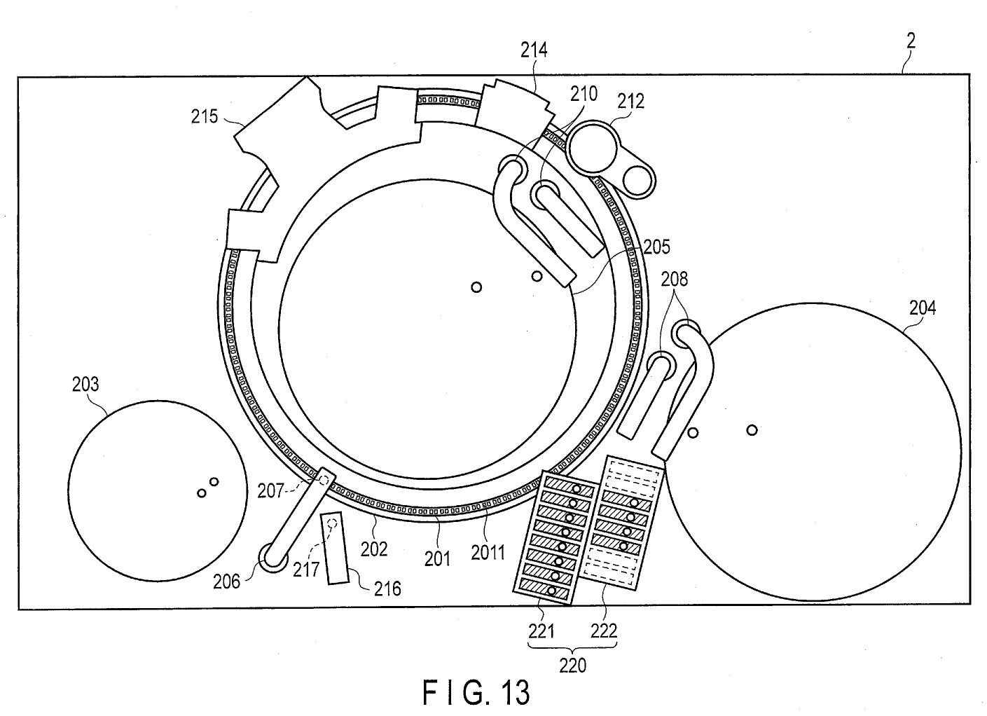

FIG. 13 is a plan view showing the arrangement of the analysis mechanism of an automatic analyzing apparatus according to the second embodiment. An analysis mechanism 2 shown in FIG. 13 further includes a linear motion reagent storage 220 in addition to each unit of the analysis mechanism 2 shown in FIG. 4 in the first embodiment. The analysis mechanism 2 also includes a reagent supply pump unit (not shown).

The linear motion reagent storage 220 holds, for example, a plurality of reagent bottles (reagent cartridges) that store the second reagent and have a dispensing function. The reagent cartridge will be described later. The linear motion reagent storage 220 includes a movable reagent storage 221 and a stationary reagent storage 222. In the example shown in FIG. 13, the linear motion reagent storage 220 is arranged immediately above a reaction disk 201 and at a position where the linear motion reagent storage 220 does not interfere with the operation of first reagent dispensing arms 208 and the like. Note that the linear motion reagent storage 220 may include a barcode reader and a guide rail (neither is shown).

The movable reagent storage 221 can hold a plurality of reagent cartridges and includes a first driving unit (not shown) capable of linearly moving the overall movable reagent storage 221 along the guide rail. The first driving unit can move the reagent cartridge in a direction (perpendicular direction) horizontally perpendicular to the extending direction of the guide rail. The first driving unit is formed from, for example, a uniaxial or multiaxial linear motion arm.

The movable reagent storage 221 can move the reagent supply probe of a reagent cartridge corresponding to a determined measurement item to a first reagent provide position on the reaction disk 201 under the control of control circuitry 9.

When the first reagent dispensing arms 208 operate, the movable reagent storage 221 moves under the control of the control circuitry 9 to a position where the movable reagent storage 221 does not contact the first reagent dispensing arms 208.

The stationary reagent storage 222 can hold a plurality of reagent cartridges. The stationary reagent storage 222 includes a second driving unit (not shown) capable of linearly moving the reagent cartridge in the perpendicular direction. The second driving unit is formed from, for example, a uniaxial or multiaxial linear motion arm.

The barcode reader identifies, for example, a reagent barcode attached to a reagent cartridge placed in the stationary reagent storage 222 under the control of the control circuitry 9. The control circuitry 9 associates the position of the stationary reagent storage 222 with information of the reagent cartridge. When the reagent cartridge is moved from the stationary reagent storage 222 to the movable reagent storage 221, the control circuitry 9 may associate the position of the movable reagent storage 221 with information of the reagent cartridge.

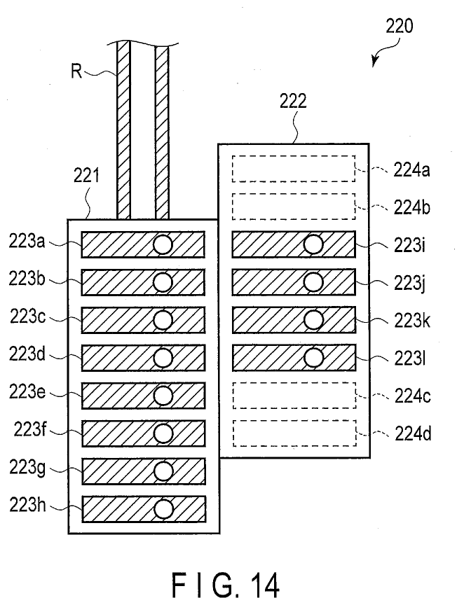

FIG. 14 is a schematic view for explaining the arrangement of a reagent unit in FIG. 13. The movable reagent storage 221 in FIG. 14 can linearly move in a rail direction along a guide rail R. The movable reagent storage 221 holds, for example, eight reagent cartridges 223a to 223h. The stationary reagent storage 222 holds, for example, four reagent cartridges 223i to 223l. The four reagent cartridges are equivalent to, for example, substitutes for replacing reagent cartridges held in the movable reagent storage 221. The stationary reagent storage 222 has four retraction positions 224a to 224d. The four retraction positions are set to, for example, retract reagent cartridges held in the movable reagent storage 221.

A driving unit (not shown) is implemented by, for example, a gear, a stepping motor, and a belt conveyor. The driving unit linearly moves the movable reagent storage 221 along the guide rail R under the control of the control circuitry 9. The driving unit moves reagent cartridges held in the movable reagent storage 221 to retraction positions in the stationary reagent storage 222. The driving unit moves a reagent cartridge held in the movable reagent storage 221 to an empty position in the stationary reagent storage 222. The empty position is equivalent to, for example, a position where a reagent cartridge temporarily moved from the movable reagent storage 221 to the stationary reagent storage 222 was held.

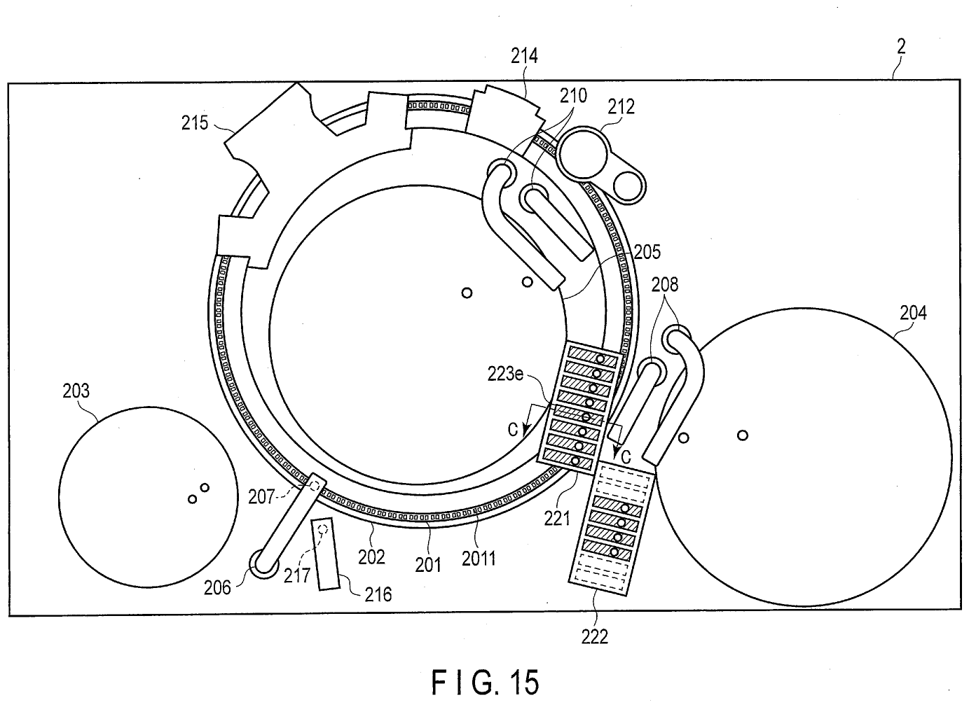

FIG. 15 is a plan view showing another example of FIG. 13. In FIG. 15, the movable reagent storage 221 is positioned immediately above the first reagent provide position. More specifically, the position of a distal end from which a reagent in the reagent cartridge 223e is provided coincides with the first reagent provide position on the reaction disk 201. The movable reagent storage 221 can linearly move so that at least the position of the distal end of each reagent cartridge can coincide with the first reagent provide position.

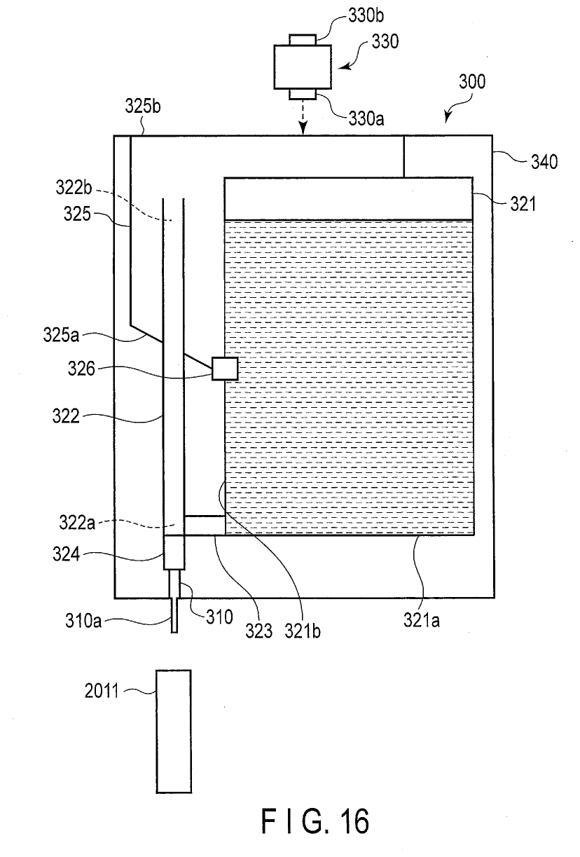

FIG. 16 is a sectional view showing a section C-C including the reagent cartridge incorporating the dispensing function in FIG. 15. A reagent cartridge 300 shown in FIG. 16 includes a case 340, and a reagent supply probe 310 and a reagent supply unit that are incorporated in the case 340. The reagent cartridge 223e shown in FIG. 15 will be explained as the reagent cartridge 300 shown in FIG. 16. Note that the “reagent supply probe” may also be called a “dispensing nozzle”.

A through hole is formed in the bottom surface of the case 340, and a distal end 310a of the reagent supply probe 310 is exposed from this hole.

The reagent supply unit includes a vessel 321, a cylinder 322, one-way valves 323 and 324, a vessel 325, and an electromagnetic valve 326.

The vessel 321 stores, for example, the second reagent. For example, the vessel 321 includes a case and a bag incorporated in the case. The case is formed from, for example, a metal or a polymer material. The bag is formed from a member more flexible than the case, such as a resin film. An example of the material of the bag is a polymer material selected from a group consisting of polyethylene, polytetrafluoro-ethylene, polypropylene, polyurethane, polyvinylidene chloride, polyvinyl chloride, polyacetal, polystylene, polyacrylonitrile, polybutylene, and the like. The bag is formed from a film (resin film) of the selected polymer material. By using this bag, the vessel 321 can prevent contact between the reagent and air. In the following description, the second reagent is stored in the vessel 321.

The one-way valve 323 is interposed between the cylinder 322 and the vessel 321. More specifically, the one-way valve 323 is interposed between a side surface of the cylinder 322 on the side of a distal end 322a and a side surface of the vessel 321 on the side of a bottom surface 321a. For example, a reagent supply pump unit 330 (to be described later) aspirates a medium, and the one-way valve 323 supplies the second reagent from the vessel 321 into the cylinder 322. The one-way valve 323 prevents a back flow from the cylinder 322 into the vessel 321.

The one-way valve 324 is interposed between the cylinder 322 and the reagent supply probe 310. More specifically, the one-way valve 324 is interposed between the distal end 322a of the cylinder 322 and the other end of the reagent supply probe 310 opposite to the distal end 310a. For example, the reagent supply pump unit 330 (to be described later) delivers the medium, and the one-way valve 324 provides the second reagent from the cylinder 322 via the reagent supply probe 310. The one-way valve 324 prevents a back flow from the reagent supply probe 310 into the cylinder 322.

The medium is aspirated or delivered to the cylinder 322. More specifically, when the reagent supply pump unit 330 (to be described later) aspirates the medium at a terminal end 322b of the cylinder 322 opposite to the distal end 322a, the second reagent flows from the vessel 321 into the cylinder 322 via the one-way valve 323. At this time, the second reagent flows into the cylinder 322 by an amount set as an analysis parameter of an inspection item. When the reagent supply pump unit 330 (to be described later) delivers the medium at the terminal end 322b of the cylinder 322, the second reagent in the cylinder 322 is provided from the reagent supply probe 310 via the one-way valve 324.

The vessel 325 is in contact with part of the side surface of the vessel 321 and part of its upper surface, and houses the terminal end 322b of the cylinder 322. More specifically, the terminal end 322b of the cylinder 322 extends through a bottom surface 325a of the vessel 325 and is housed in the vessel 325. When the second reagent flows from the vessel 321 into the cylinder 322 via the one-way valve 323, the vessel 325 stores the second reagent overflowing from the terminal end 322b of the cylinder 322.

The bottom surface 325a of the vessel 325 is so inclined as to come closer to the ground surface of the reagent storage as it comes closer to a side surface 321b of the vessel 321. That is, the bottom surface 325a of the vessel 325 has a shape with which the second reagent in the vessel 325 flows toward the side surface 321b of the vessel 321 when the second reagent overflowing from the terminal end 322b of the cylinder 322 is stored in the vessel 325.

The electromagnetic valve 326 is provided in a region where the bottom surface 325a of the vessel 325 and the side surface 321b of the vessel 321 cross each other, and makes the vessel 325 and the vessel 321 communicate with each other when the electromagnetic valve 326 is opened. For example, the electromagnetic valve 326 is opened under the control of the control circuitry 9, and the second reagent flows from the vessel 325 into the vessel 321 via the electromagnetic valve 326. That is, the second reagent stored in the vessel 325 is returned to the vessel 321.

As shown in FIG. 16, the reagent supply pump unit 330 includes a pump head 330a and a terminal 330b. When dispensing the second reagent, the terminal 330b is connected to an arm movably supporting the reagent supply pump unit 330. For example, the control circuitry 9 outputs to a driving mechanism 4 a control signal for connecting the reagent supply pump unit 330 and the reagent cartridge 300 caused to provide the second reagent. In this case, the driving mechanism 4 moves the arm movably supporting the reagent supply pump unit 330 in accordance with the control signal, and connects an upper surface 325b of the vessel 325 of the reagent supply unit of the reagent cartridge 300 and the pump head 330a of the reagent supply pump unit 330. More specifically, an opening is formed in the upper surface of the case 340, and the upper surface 325b of the vessel 325 is exposed from the opening. A through hole is formed in the exposed upper surface 325b and, for example, a rubber O-ring is provided around the hole. The pump head 330a covers or grips the O-ring to connect the upper surface 325b of the vessel 325 and the pump head 330a. An open circle of the reagent cartridge 223e in FIG. 15 corresponds to the opening.

Then, the control circuitry 9 outputs to the driving mechanism 4 a control signal for, for example, aspirating by the reagent supply pump unit 330 the medium that causes the reagent cartridge 300 to aspirate the second reagent by a predetermined amount. In this case, the driving mechanism 4 drives the reagent supply pump unit 330 in accordance with the control signal, and controls the reagent supply pump unit 330 to aspirate the medium from the pump head 330a. For example, the terminal 330b of the reagent supply pump unit 330 includes a tube for providing the medium from the driving mechanism 4 to the reagent cartridge 300 via the arm, or aspirating the medium from the reagent cartridge 300 to the driving mechanism 4 via the arm. The terminal 330b of the reagent supply pump unit 330 is connected to a signal line for controlling the reagent supply pump unit 330 by the driving mechanism 4 via the arm. In accordance with the control signal, the driving mechanism 4 controls the reagent supply pump unit 330 via the signal line so as to aspirate the medium from the pump head. 330a via the tube. In this case, the reagent supply pump unit 330 aspirates the medium at the terminal end 322b of the cylinder 322 housed in the vessel 325. As a result, the second reagent flows from the vessel 321 into the cylinder 322 via the one-way valve 323.

The predetermined amount of second reagent is slightly larger than an amount set as an analysis parameter of an inspection item. Thus, when the second reagent flows from the vessel 321 into the cylinder 322 via the one-way valve 323, it flows into the cylinder 322 by the amount set as the analysis parameter of the inspection item, and the second reagent slightly overflowing from the terminal end 322b of the cylinder 322 is stored in the vessel 325. At this time, the second reagent in the vessel 325 flows toward the side surface 321b of the vessel 321 because the bottom surface 325a of the vessel 325 is inclined.

Then, the control circuitry 9 outputs to the driving mechanism 4 a control signal for injecting from the reagent supply pump unit 330 into the reagent cartridge 300 the medium for providing the second reagent. In this case, the driving mechanism 4 drives the reagent supply pump unit 330 in accordance with the control signal, and controls the reagent supply pump unit 330 to deliver the medium from the pump head 330a. For example, the driving mechanism 4 controls the reagent supply pump unit 330 via the signal line in accordance with the control signal so as to deliver the medium from the pump head 330a via the tube. In this case, the medium is delivered from the reagent supply pump unit 330 at the terminal end 322b of the cylinder 322 housed in the vessel 325. The second reagent flowing into the cylinder 322 is provided from the reagent supply probe 310 via the one-way valve 324.

The electromagnetic valve 326 can return the second reagent stored in the vessel 325 to the vessel 321. More specifically, the electromagnetic valve 326 includes a main body and a valve, and the control circuitry 9 outputs to the main body by, for example, a wireless signal a control signal for opening the valve. The main body opens the valve in accordance with the control signal output from the control circuitry 9. At this time, the second reagent flows from the vessel 325 into the vessel 321 via the electromagnetic valve 326.

Upon completion of dispensing the second reagent, the control circuitry 9 outputs to the driving mechanism 4 a control signal for, for example, disconnecting the reagent supply pump unit 330 and the reagent cartridge 300 from which the second reagent has been provided. In this case, the driving mechanism 4 disconnects the upper surface 325b of the vessel 325 of the reagent supply unit of the reagent cartridge 300 and the pump head 330a of the reagent supply pump unit 330 in accordance with the control signal.

Note that the processing of returning the second reagent in the vessel 325 to the vessel 321 need not be performed every time the second reagent is provided. For example, this processing may be performed intermittently after the second reagent is provided a plurality of times.

Since only a small amount of second reagent is stored in the vessel 325 of the reagent cartridge 300, the processing of returning the second reagent in the vessel 325 to the vessel 321 may not be performed. That is, if the amount of second reagent stored in the vessel 325 is very small, the second reagent in the vessel 325 may be discarded. In this case, the electromagnetic valve 326 need not be installed.

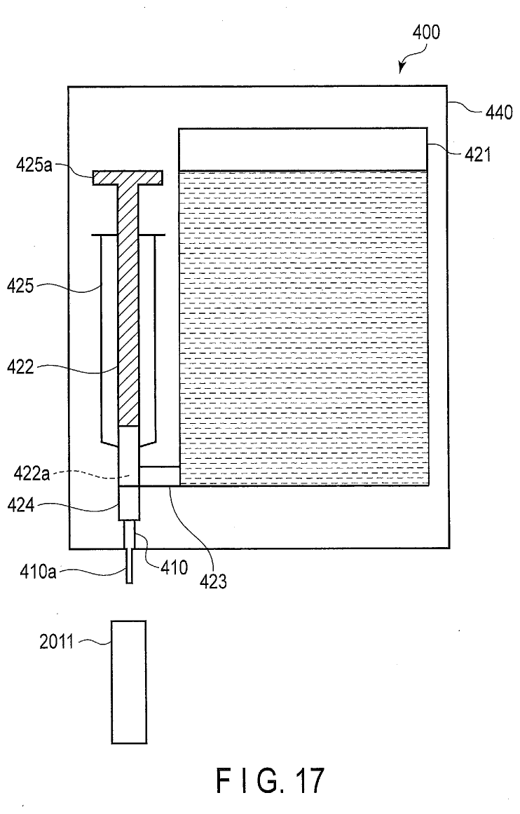

FIG. 17 is a sectional view showing another reagent cartridge in FIG. 16. A reagent cartridge 400 shown in FIG. 17 includes a case 440, and a reagent supply probe 410 and a reagent supply unit that are incorporated in the case 440. The reagent supply unit in FIG. 17 is mainly formed from a syringe. When the reagent cartridge 400 is used, a driving mechanism configured to drive the syringe is used instead of the reagent supply pump unit.

A through hole is formed in the bottom surface of the case 440, and a distal end 410a of the reagent supply probe 410 is exposed from this hole.

The reagent supply unit includes a vessel 421, a cylinder 422, one-way valves 423 and 424, and a syringe having an outer casing 425 and a plunger 425a. Note that the vessel 421, cylinder 422, and one-way valves 423 and 424 are almost similar to the above-described vessel 321, cylinder 322, and one-way valves 323 and 324, and a description thereof will not be repeated.

The outer casing 425 is integrated with, for example, the cylinder 422 and increases the rigidity of the cylinder 422. The plunger 425a is placed inside the cylinder 422 and can be moved in an insertion direction or an extraction direction by a driving mechanism (not shown). The insertion direction is a direction in which a reagent is provided, and the extraction direction is an opposite direction. The driving mechanism (not shown) moves the plunger 425a in the insertion direction or the extraction direction.

When the plunger 425a is moved in the extraction direction, the internal pressure in the cylinder 422 decreases. When the internal pressure in the cylinder 422 decreases, the second reagent in the vessel 421 flows into a distal end 422a of the cylinder 422 via the one-way valve 423.

When the plunger 425a is moved in the insertion direction, the internal pressure in the cylinder 422 increases. When the internal pressure in the cylinder 422 increases, the second reagent in the cylinder 422 is provided from the distal end 410a of the reagent supply probe 410 via the one-way valve 424.

In this manner, the syringe-incorporated reagent cartridge 400 includes the mechanism of driving the plunger 425a when aspirating and providing the second reagent. The reagent cartridge 400 can be used to simplify the driving mechanism in comparison with the above-described reagent cartridge 300.

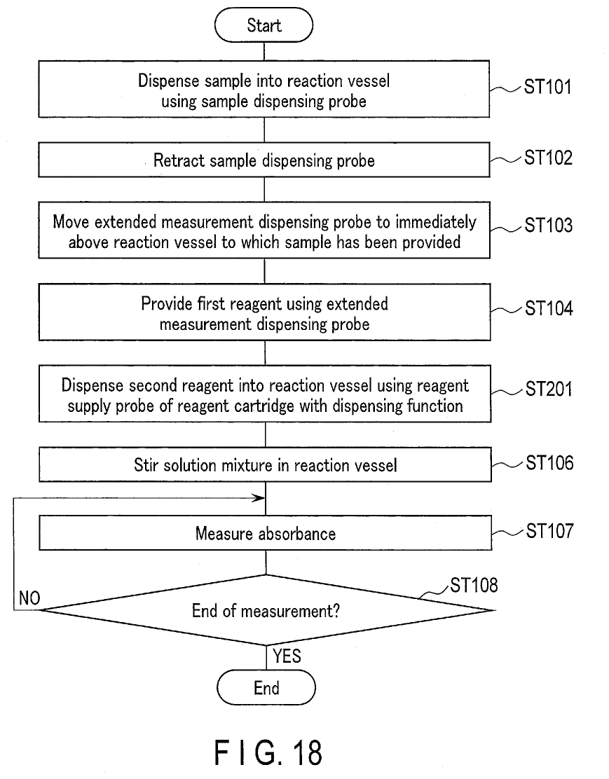

FIG. 18 is a flowchart showing an example of an analysis operation according to the second embodiment. The flowchart in FIG. 18 starts when, for example, the operator executes a dispensing control processing program.

In the second embodiment, when executing the dispensing control processing program, a reagent tank (not shown) stores a buffer solution (first reagent) and the linear motion reagent storage 220 holds a plurality of reagent vessels storing the second reagent. More specifically, dispensing control in the second embodiment uses the first reagent in the reagent tank and the second reagent in the linear motion reagent storage 220.

In the flowchart of FIG. 18, for example, the reagent supply probe of the reagent cartridge 223e is arranged at the first reagent dispensing position, as shown in FIG. 15. Step ST101 to step ST104, step ST106, and step ST107 have been described above and a description thereof will not be repeated. After pivoting the reaction disk 201 after step ST104, the process advances to step ST201.

(Step ST201)

After pivoting a reaction vessel to which the sample and the first reagent have been dispensed, the control circuitry 9 dispenses the second reagent into the reaction vessel using the reagent supply probe of the reagent cartridge 223e. More specifically, the reagent supply probe provides a predetermined amount of second reagent into a reaction vessel 2011 by aspirating and delivering the medium by the reagent supply pump unit. That is, the second reagent is provided into the reaction vessel 2011 at the first reagent provide position.

After step ST201, the control circuitry 9 pivots the reaction disk 201 by, for example, two cycles By this pivoting, the reaction vessel 2011 at the first reagent provide position moves to the stirring position. After this operation, the process advances to step ST106.

Note that a series of processes from step ST101 to step ST104 and step ST201 is performed while the reaction disk makes a round. That is, the sample, the first reagent, and the second reagent are provided into the reaction vessel in a period in which the reaction disk makes a round.

The above operation will be summarized. A automatic analyzing apparatus 1 includes the reaction disk 201 configured to hold a plurality of reaction vessels including the reaction vessels 2011, the sample dispensing probe 207 configured to provide a sample into the reaction vessel 2011 stopping at the sample provide position on the reaction disk 201, the extended measurement dispensing probe 217 configured to dispense the first reagent into the reaction vessel 2011 stopping at the sample provide position (first position), the control circuitry 9 configured to move the reaction vessel 2011 stopping at the first position on the reaction disk 201 to the first reagent provide position (second position) by pivoting the reaction disk 201 by one cycle, and the reagent cartridge configured to provide the second reagent into the reaction vessel 2011 stopping at the second position.

As described above, the automatic analyzing apparatus according to the second embodiment includes the reaction disk configured to hold a plurality of reaction vessels, the sample dispensing probe configured to provide a sample into the reaction vessel stopping at the first position on the reaction disk, the extended measurement dispensing probe configured to provide the first reagent into the reaction vessel stopping at the first position, the control unit configured to move the reaction vessel stopping at the first position on the reaction disk to the second position by pivoting the reaction disk at a predetermined pivot angle, and the reagent cartridge including the reagent dispensing probe configured to provide the second reagent into the reaction vessel stopping at the second position. The automatic analyzing apparatus according to the second embodiment may include the reagent storage that is arranged above the reaction disk and holds the reagent cartridges, and the control unit may move to the second position the opening of the reagent cartridge corresponding to the opening of the sample dispensing probe.

Similar to the automatic analyzing apparatus according to the first embodiment, the automatic analyzing apparatus according to the second embodiment can perform analysis in a different inspection process while maintaining the processing speed.

Further, the automatic analyzing apparatus can cope with a larger number of inspection items because it can increase the types of reagents used in inspection by using reagent cartridges that are held in the linear motion reagent storage and have the dispensing function. In other words, the automatic analyzing apparatus can add inspection items in a conventional automatic analyzing apparatus and meet a request to increase inspection items.

### First Application Example of Second Embodiment

In the second embodiment, the second reagent to be dispensed into the reaction vessel is stored in the linear motion reagent storage. In this application example, an operation to replace a reagent cartridge in the linear motion reagent storage will be explained. The reagent cartridge replacement operation is to replace a reagent cartridge (empty reagent cartridge) with no second reagent held in the movable reagent storage 221 with a reagent cartridge for replacement (replacement reagent cartridge) held in the stationary reagent storage 222.

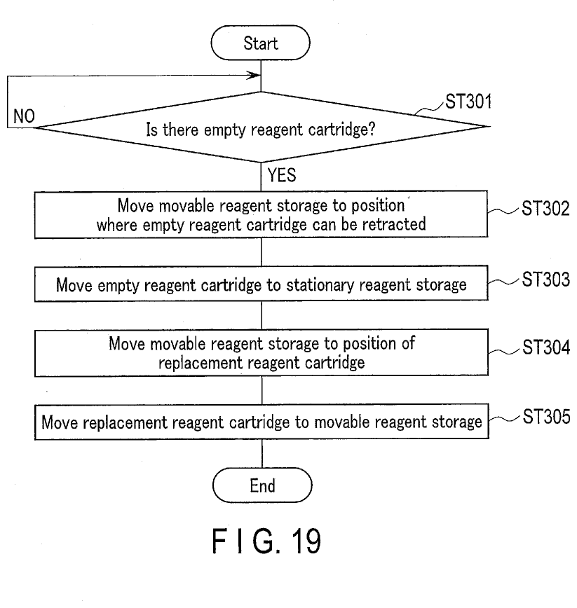

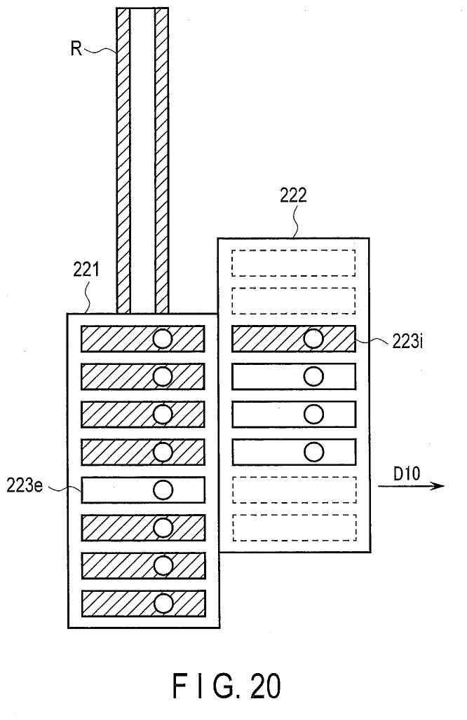

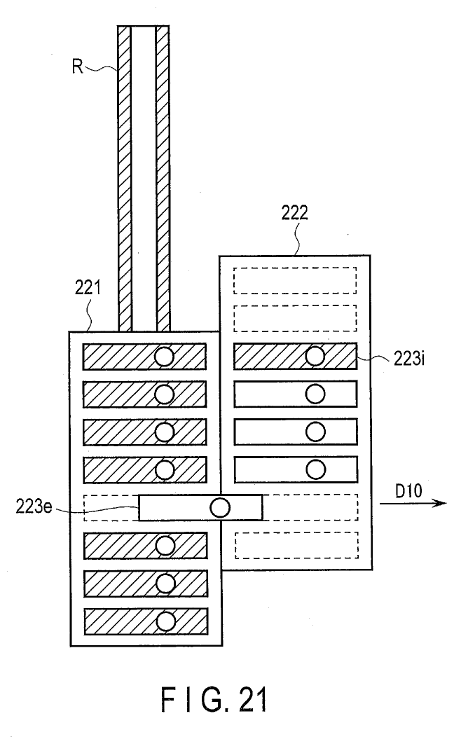

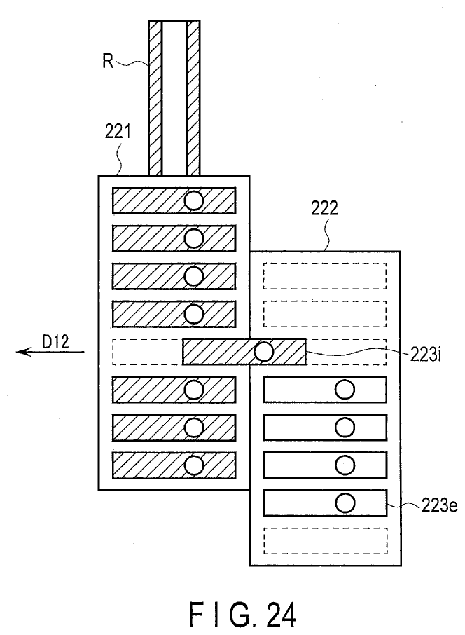

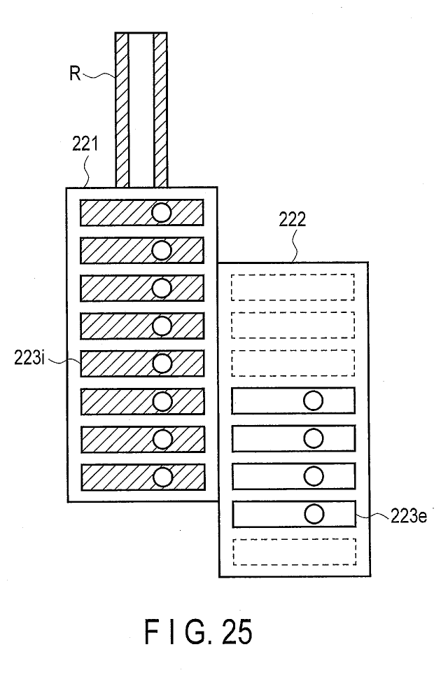

The reagent cartridge replacement operation will be described below with reference to the flowchart of FIG. 19 and schematic views for explaining the reagent cartridge replacement operation shown in FIGS. 20, 21, 22, 23, 24, and 25.

FIG. 19 is a flowchart showing an example of the reagent cartridge replacement operation according to the application example of the second embodiment. The flowchart of FIG. 19 is executed as a reagent cartridge replacement processing program during, for example, execution of the dispensing control processing program according to the second embodiment.

(Step ST301)

During execution of the dispensing control processing, the control circuitry 9 determines whether there is an empty reagent cartridge. If there is an empty reagent cartridge, the process advances to step ST302. If there is no empty reagent cartridge, the determination processing is repeated.

More specifically, the control circuitry 9 accepts a control signal regarding reagent cartridge replacement from the linear motion reagent storage 220. After accepting the control signal, the control circuitry 9 executes reagent cartridge replacement processing. The process then advances to step ST302.

For example, a case in which the reagent cartridge 223e in the movable reagent storage 221 is emptied and replaced with the reagent cartridge 223i in the stationary reagent storage 222 will be explained.

(Step ST302)

After the start of reagent cartridge replacement processing, the control circuitry 9 moves the movable reagent storage to a position where the empty reagent cartridge can be retracted. More specifically, the first driving unit of the movable reagent storage 221 temporarily stops the second reagent dispensing operation using the reagent cartridge and moves the movable reagent storage 221 under the control of the control circuitry 9.

For example, as shown in FIG. 20, the first driving unit moves the movable reagent storage 221 so that the empty reagent cartridge 223e and the retraction position in the stationary reagent storage 222 become adjacent to each other in the perpendicular direction.

(Step ST303)

After moving the movable reagent storage, the control circuitry 9 moves the empty reagent cartridge to the stationary reagent storage. More specifically, as shown in FIGS. 20, 21, and 22, the first driving unit of the movable reagent storage 221 moves the empty reagent cartridge 223e to the retraction position in the stationary reagent storage 222 under the control of the control circuitry 9. For example, the empty reagent cartridge 223e moves in the direction of an arrow D10.

When moving the reagent cartridge from the movable reagent storage 221 to the stationary reagent storage 222, the second driving unit of the stationary reagent storage 222 may be further driven.

(Step ST304)

After moving the empty reagent cartridge, the control circuitry 9 moves the movable reagent storage to the position of a replacement reagent cartridge. More specifically, the first driving unit of the movable reagent storage 221 moves the movable reagent storage 221 under the control of the control circuitry 9.

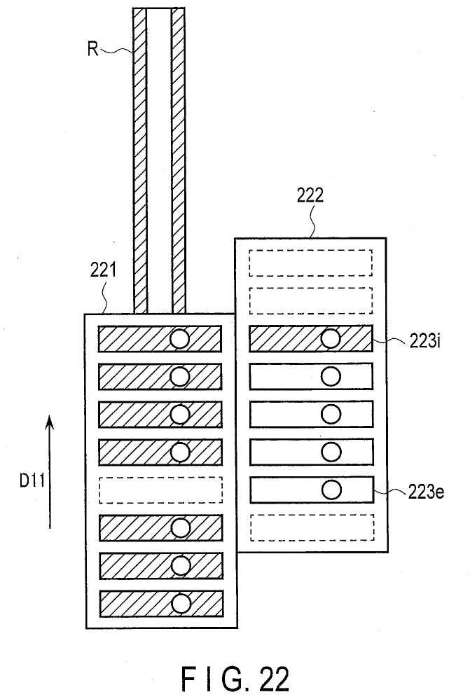

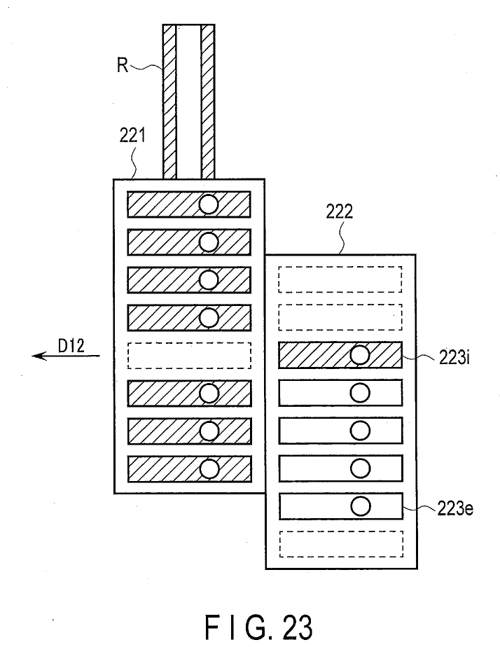

For example, as shown in FIGS. 22 and 23, the first driving unit moves the movable reagent storage 221 so that an empty position in the movable reagent storage 221 and the reagent cartridge 223i in the stationary reagent storage 222 become adjacent to each other in the perpendicular direction. For example, the movable reagent storage 221 moves in the direction of an arrow D11.

(Step ST305)

After moving the movable reagent storage, the control circuitry 9 moves the replacement reagent cartridge to the movable reagent storage. More specifically, as shown in FIGS. 23, 24, and 25, the second driving unit of the stationary reagent storage 222 moves the replacement reagent cartridge 223i to the empty position in the movable reagent storage 221 under the control of the control circuitry 9. For example, the replacement reagent cartridge 223i moves in the direction of an arrow D12. When moving the reagent cartridge from the stationary reagent storage 222 to the movable reagent storage 221, the first driving unit of the movable reagent storage 221 may be further driven.

As described above, in addition to the automatic analyzing apparatus according to the second embodiment, the automatic analyzing apparatus according to the application example of the second embodiment includes the movable reagent storage configured to be movable in the array direction of reagent cartridges, and the stationary reagent storage configured to hold replacement reagent cartridges. The control unit can replace a reagent cartridge in the movable reagent storage with a reagent cartridge in the stationary reagent storage.

Similar to the automatic analyzing apparatus according to the first embodiment and the automatic analyzing apparatus according to the second embodiment, the automatic analyzing apparatus according to the application example of the second embodiment can perform analysis in a different inspection process while maintaining the processing speed. Further, the automatic analyzing apparatus can automatically replace, for example, an empty reagent cartridge held in the movable reagent storage with a replacement reagent cartridge held in the stationary reagent storage.

### Second Application Example of Second Embodiment

The linear motion reagent storage is used in the second embodiment and the first application example of the second embodiment, but the reagent storage is not limited to this. For example, a circular reagent storage including a reagent cartridge rack configured to annularly array and hold a plurality of reagent cartridges may be adopted instead of the linear motion reagent storage.

The circular reagent storage according to this application example holds, for example, a plurality of reagent cartridges storing the second reagent. In the circular reagent storage, the reagent cartridge rack is provided rotatably. The reagent cartridge rack annularly arrays and holds a plurality of reagent cartridges. The reagent cartridge rack is pivoted by, for example, the driving mechanism 4. The circular reagent storage is arranged immediately above the reaction disk 201 and at a position where the circular reagent storage does not interfere with the operation of the first reagent dispensing arms 208 and the like.

The circular reagent storage can move the reagent supply probe of a reagent cartridge corresponding to a determined setting item to the first reagent provide position on the reaction disk 201 under the control of control circuitry 9.

### Another Embodiment

The reagent dispensing probe according to each of the above embodiments is applied to an automatic analyzing apparatus that executes biochemical inspection, but is not limited to this. For example, the reagent dispensing probe may be applied to, for example, an automatic analyzing apparatus that executes blood coagulation analysis inspection.

The automatic analyzing apparatus according to another embodiment can execute blood coagulation analysis inspection and has an arrangement similar to that in FIG. 1. The automatic analyzing apparatus according to the other embodiment will be described with reference to FIG. 1.

An analysis mechanism 2 mixes a blood specimen and a reagent used for each inspection item. Depending on an inspection item, the analysis mechanism 2 mixes a standard solution diluted at a predetermined magnification, and a reagent used for the inspection item. Note that the solution mixture is reacted at a constant temperature of, for example, 37° optimal for enzyme reaction of a living body.

The analysis mechanism 2 successively measures optical property values of the solution mixture of the blood specimen or the standard solution, and the reagent. By this measurement, standard data and inspection target data represented by, for example, the transmitted light intensity or the absorbance, and the scattered light intensity are generated.

Analysis circuitry 3 is a processor configured to generate calibration data about coagulation of the blood specimen and analysis data by analyzing the standard data and inspection target data generated by the analysis mechanism 2. The analysis circuitry 3 reads out an analysis program from storage circuitry 8, and generates standard data and inspection target data in accordance with the readout analysis program.

More specifically, the analysis circuitry measures the process of coagulation in the solution mixture by analyzing, for example, the inspection target data. For example, as for analysis of a solution mixture to which a highly reactive reagent is added, the analysis circuitry 3 analyzes inspection target data obtained by detecting transmitted light. For example, as for analysis of a solution mixture to which a slow and less reactive reagent is added, the analysis circuitry 3 analyzes inspection target data obtained by detecting scattered light. The analysis circuitry 3 obtains a change of the received light intensity for a blood coagulation reaction based on the inspection target data. The analysis circuitry 3 calculates, from a reaction curve representing the change of the received light intensity, information about coagulation of the blood specimen, for example, the coagulation end point, the coagulation point, and the coagulation time.

Depending on an inspection item, the analysis circuitry 3 calculates a concentration value and the like based on the calculated coagulation time and calibration data of the inspection item corresponding to the inspection target data. The analysis circuitry 3 outputs to control circuitry 9 analysis data including the coagulation end point, the coagulation point, the coagulation time, the concentration value, and the like.

According to at least one of the above-described embodiments, analysis in a different inspection process can be performed while maintaining the processing speed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An automatic analyzing apparatus comprising:
a reaction disk configured to hold a plurality of reaction vessels;
a sample dispensing probe configured to provide a sample;
an extended measurement dispensing probe configured to provide a first reagent;
a reagent dispensing probe configured to provide a second reagent; and
processing circuitry configured to:
provide the sample into the reaction vessel stopping at a first position on the reaction disk using the sample dispensing probe;
provide the first reagent into the reaction vessel stopping at the first position using the extended measurement dispensing probe;
move the reaction vessel stopping at the first position on the reaction disk to a second position by pivoting the reaction disk at a predetermined pivot angle; and
provide the second reagent into the reaction vessel stopping at the second position using the reagent dispensing probe.

2. The automatic analyzing apparatus according to claim 1, wherein within one round in a period in which the reaction disk pivots at the predetermined pivot angle, the processing circuitry is further configured to:
provide the sample into the reaction vessel stopping at the first position using the sample dispensing probe; and
provide the first reagent into the reaction vessel stopping at the first position using the extended measurement dispensing probe.

3. The automatic analyzing apparatus according to claim 1, wherein the processing circuitry is further configured to move the reaction vessel stopping at the first position to the second position by pivoting the reaction disk while the reaction disk makes a round.

4. The automatic analyzing apparatus according to claim 1, wherein the processing circuitry is further configured to:
perform rotation and stop in every cycle using the reaction disk; and
dispense the sample and the first reagent during a stop period in one cycle using the sample dispensing probe and the extended measurement dispensing probe.

5. The automatic analyzing apparatus according to claim 1, further comprising a reagent storage arranged above the reaction disk and configured to hold a reagent cartridge including the reagent dispensing probe,
wherein the processing circuitry is further configured to move an opening of the reagent cartridge corresponding to an opening of the reagent dispensing probe to the second position by pivoting the reaction disk.

6. The automatic analyzing apparatus according to claim 5, wherein the reagent storage further comprises:
a movable reagent storage configured to be movable in an array direction of the reagent cartridge; and
a stationary reagent storage configured to hold a reagent cartridge for replacement,
wherein the processing circuitry is further configured to replace the reagent cartridge in the movable reagent storage with the reagent cartridge in the stationary reagent storage.

7. An automatic analyzing apparatus comprising:
a reaction disk configured to hold a plurality of reaction vessels;
a sample dispensing probe configured to provide a sample;
a reagent storage arranged above the reaction disk and configured to hold a plurality of reagent cartridges with a dispensing function each including a dispensing nozzle for providing a first reagent; and
processing circuitry configured to:
provide the sample into the reaction vessel stopping at a first position on the reaction disk using the sample dispensing probe; and
move the reaction vessel stopping at the first position on the reaction disk to a second position by pivoting the reaction disk at a predetermined pivot angle.

8. The automatic analyzing apparatus according to claim 7, further comprising a reagent dispensing probe configured to provide a second reagent different from the first reagent,
wherein the processing circuitry is further configured to:
move the reaction vessel stopping at the second position on the reaction disk to a third position by pivoting the reaction disk; and
provide the second reagent into the reaction vessel stopping at the third position using the reagent dispensing probe.

9. The automatic analyzing apparatus according to claim 8, wherein within one round in a period in which the reaction disk pivots at the predetermined pivot angle, the processing circuitry is further configured to:
provide the sample into the reaction vessel stopping at the first position using the sample dispensing probe;
provide the first reagent into the reaction vessel stopping at the second position using the dispensing nozzle; and
provide the second reagent into the reaction vessel stopping at the third position using the reagent dispensing probe.

10. The automatic analyzing apparatus according to claim 7, wherein the reagent storage further comprises:
a movable reagent storage configured to be movable in an array direction of the reagent cartridges; and
a stationary reagent storage configured to hold a reagent cartridge for replacement,
wherein the processing circuitry is further configured to replace the reagent cartridge in the movable reagent storage with the reagent cartridge in the stationary reagent storage.

11. An automatic analyzing apparatus comprising:
a reaction disk configured to hold a plurality of reaction vessels;
a sample dispensing probe configured to provide a sample;
a reagent storage configured to hold a plurality of reagent bottles each including a reagent dispensing nozzle;
a moving mechanism configured to move an arbitrary reagent bottle in an array direction of the reagent bottles and move the reagent dispensing nozzle of the arbitrary reagent bottle to above the reaction vessel; and
processing circuitry configured to:
provide the sample into the reaction vessel stopping at a first position on the reaction disk using the sample dispensing probe; and
control dispensing of a reagent by the reagent dispensing nozzle to dispense the reagent from the reagent dispensing nozzle into the reaction vessel.

12. The automatic analyzing apparatus according to claim 11, further comprising:
a rotary reagent storage configured to annularly array and hold a plurality of reagent vessels; and
a reagent dispensing probe configured to aspirate a reagent from the reagent vessel held by the rotary reagent storage and provide the reagent into the reagent vessel.

13. The automatic analyzing apparatus according to claim 12, wherein the processing circuitry is further configured to move the reaction vessel stopping at the first position on the reaction disk to a second position by pivoting the reaction disk at a predetermined pivot angle,
wherein the reagent dispensing nozzle and the reagent dispensing probe are capable of dispensing into the reagent vessel stopping at the second position.

14. The automatic analyzing apparatus according to claim 13, wherein within one round in a period in which the reaction disk pivots at the predetermined pivot angle, the processing circuitry is further configured to:
provide the sample into the reaction vessel stopping at the first position using the sample dispensing probe; and
provide the reagent into the reaction vessel stopping at the second position using one of the reagent dispensing nozzle and the reagent dispensing probe.

15. The automatic analyzing apparatus according to claim 11, wherein the processing circuitry is further configured to:
move the reaction vessel stopping at the first position on the reaction disk to the second position by pivoting the reaction disk at the predetermined pivot angle; and
provide the reagent into the reaction vessel stopping at the second position using the reagent dispensing nozzle.
